(19) United States
(12) Patent Application Publication
(10) Pub. No.: US 2026/0360273 A1
(43) Pub. Date: Nov. 12, 2026

(54) WhatYouWrote(TM) -- A Method for Ensuring that Students Understand the Contents of What They Submit for Assignments in the Era of Artificial Intelligence (AI)

(71) Applicant: Robert A. Connor, Wyoming, MN (US)

(72) Inventor: Robert A. Connor, Wyoming, MN (US)

(73) Assignee: Holovisions LLC, Ham Lake, MN (US)

(21) Appl. No.: 19/313,795

(22) Filed: Aug. 28, 2025

Related U.S. Application Data
(63) Continuation-in-part of application No. 18/393,175, filed on Dec. 21, 2023.
Application No. 18/393,175 is a continuation-in-part of application No. 18/195,886, filed on May 10, 2023, now Pat. No. 11,853,708.

(51) Int. Cl. G09B 7/06; G06F 40/247

(52) U.S. Cl. CPC G09B 7/06; G06F 40/247

(57) ABSTRACT

Disclosed herein is a method for measuring a student's knowledge of a body of text submitted for an assignment. Regardless of the extent to which a student uses AI to help write their assignment, they should understand the content of what they submit. This method can include receiving a body of text submitted for an assignment by a student and then creating questions for the student based on the body of text. These questions form a quiz to measure the student's knowledge of content in the submitted body of text.

### CROSS-REFERENCE TO RELATED APPLICATIONS

This application is a continuation-in-part of U.S. patent application Ser. No. 18/393,175 filed on Dec. 21, 2023. U.S. patent application Ser. No. 18/393,175 was a continuation-in-part of U.S. patent application Ser. No. 18/195,886 filed on May 10, 2023 which issued as U.S. Pat. No. 11,853,708 on Dec. 26, 2023.

The entire contents of these related applications are incorporated herein by reference.

### FEDERALLY SPONSORED RESEARCH: Not Applicable

### SEQUENCE LISTING OR PROGRAM: Not Applicable

### BACKGROUND—FIELD OF INVENTION: This invention relates to methods to ensure that students learn course material through assignments.

### INTRODUCTION

Thoughtful use of Artificial Intelligence (AI) can be useful for learning and education, but students may be tempted to use AI in an unthoughtful manner. Unthoughtful use of AI can erode learning and education. In the extreme, some students may use AI to completely compose their course assignments and not learn course material. In response, instructors may be tempted to use AI detectors rather than invest the effort required for detective work to investigate whether an assignment was really done by a student. The result can be a “Battle of the Bots” between students and instructors, rather than a productive and rewarding educational experience. A better solution is needed to avoid a “Battle of the Bots” and to keep the focus on student learning.

### REVIEW OF THE RELEVANT ART

U.S. Pat. No. 10,467,919 (Fuka, Nov. 5, 2019, “Systems and Methods for AI-Based Student Tutoring”) discloses dynamic assessment by an expert system software module, wherein the system determines a set of diagnostic questions to identify a student's strengths and/or weaknesses for a given subject matter. U.S. Patent Application Publication 20180046712 (Henderson et al., Feb. 15, 2018, “Artificial Intelligence Content Detection System”) discloses technologies for artificial intelligence with a pattern detector that analyzes content generated as a result of an internet search engine search query.

U.S. Patent Application Publication 20190362642 (Dhamecha et al., Nov. 28, 2019, “Tutoring Agent Improvement Recommendation”) discloses a method for receiving a plurality of transcripts of interactions between a student and a tutoring agent and determining an improvement to the tutoring agent. U.S. Patent Application Publication 20220319181 (Kanuganti et al., Oct. 6, 2022, “Artificial Intelligence (AI)-Based System and Method for Managing Education of Students in Real-Time”) discloses a method for managing student education by receiving learning data associated with an online mode and an offline mode from data capturing devices.

U.S. Pat. No. 11,990,139 (Sandrew, May 21, 2024, “System That Conducts Dialogs Using Artificial Intelligence”) discloses an artificial intelligence system that conducts dialogs to achieve teaching material with a Socratic question-and-answer method, review material to reinforce ideas or to prepare a participant for future tests or events, or evaluate a participant's knowledge or communication skills. U.S. Pat. No. 12,057,032 (Khanwalkar et al., Aug. 6, 2024, “Auto-Solving Multiple-Choice Questions”) discloses automated solving of multiple-choice questions given a question and a set of answer options.

U.S. Patent Application Publication 20240378133 (Imaffei et al., Nov. 14, 2024, “System and Method for Deterring and Detecting Artificial Intelligence Use in Electronic File Composition”) discloses a method for determining whether content was generated using artificial intelligence, wherein the method includes tracking and analyzing words typed, keystrokes, and total word count. U.S. Patent Application Publication 20250062909 (Su et al., Feb. 20, 2025, “AI-Generated Content Detection”) discloses a method for detecting content generated by artificial intelligence by monitoring interactions between a user and a generative AI model.

U.S. Patent Application Publication 20250141857 (Lu et al., May 1, 2025, “System and Method for Detecting and Verifying A.I.-Generated Material”) discloses a method for detecting and verifying AI-generated material by receiving submitted material and analyzing the material for attributes characteristic of (prior) AI-generated vs. human-generated material. U.S. Patent Application Publication 20250245433 (Izzo, Jul. 31, 2025, “Detecting Artificial Intelligence Generated Text in Large Document Corpora”) discloses systems and methods for detecting artificial intelligence generated text in large document corpora using token statistics.

U.S. Patent Application Publication 20250252263 (Yang et al., Aug. 7, 2025, “Systems and Methods for Detecting Generated Text Through Rewriting Operations”) discloses systems and methods for detecting machine-generated content by the extent to which rewritten versions are semantically similar to an original written input.

### SUMMARY OF THE INVENTION

This invention, WhatYouWrote (TM), is a method for measuring a student's knowledge of a body of text submitted by the student for an assignment. Regardless of the extent to which a student uses a machine process (such as AI) to help write their assignment, the student should be responsible for understanding the content of what they submit. Unlike software which seeks to detect AI-generated content and give an instructor a “percentage” or “probability” figure, this method keeps the focus on learning, not detective work. This method can include receiving a body of text submitted for an assignment by a student and then creating questions for the student based on the body of text. These questions form an assessment tool, such as a quiz, to measure the student's knowledge of content in the submitted body of text.

In an example, this method can create a quiz question which tests whether the student can differentiate between a string (e.g. word, phrase, or statement) which is in the body of text vs. a string which is not in the body of text. In another example, this method can create a quiz question which tests whether the student knows the meaning of a target string (e.g. word, phrase, or statement) which is in the body of text. For example, the student can be asked to identify a string with a meaning similar to that of the target string (e.g. a synonym) from among a plurality of alternative presented strings. In an example, a target string can be selected from a submitted body of text as the basis for a question based on one or more of the following string attributes: rarity or infrequency in a previously-analyzed large body of text; vocabulary level; and relevance to the topic of the assignment.

### BRIEF INTRODUCTION TO THE FIGURES

FIG. 1 shows steps for a method for measuring a student's knowledge of a body of text submitted for an assignment comprising: receiving the body of text; selecting words, phrases, or statements from the body of text; and creating questions to measure the student's knowledge of content in the body of text.

### DETAILED DESCRIPTION OF THE FIGURES

Thoughtful use of Artificial Intelligence (AI) can be useful for learning and education, but students may be tempted to use AI in an unthoughtful manner. Unthoughtful use of AI can erode learning and education. In the extreme, some students may use AI to completely compose their course assignments and not learn course material. In response, instructors may be tempted to use AI detectors rather than invest the effort required for detective work to investigate whether an assignment was really done by a student. The result can be a “Battle of the Bots” between students and instructors, rather than a productive and rewarding educational experience. The method disclosed herein helps to avoid this “Battle of the Bots” and keep the focus on learning, not detection, in the age of AI.

A method for testing and confirming students' understanding of the contents of bodies of text which they submit for assignments is a technological advance which addresses problems including: erosion of critical thinking skills by unquestioning acceptance of machine-generated output; erosion of individuality and self-actualization; erosion of learning by thoughtless use of machine processes (e.g. artificial intelligence) by students to write assignments; erosion of learning by weakened engagement and effort; erosion of trust in student-instructor relationships; inability to measure student competence and performance; inefficient use of instructor time when they would otherwise have to play detective as opposed to educating; undermining preparation for future career roles; and undermining rewards for excellence in authentic student work.

The methods disclosed herein for testing a student's understanding of submitted work are a technological advancement over methods for estimating whether the work is written by artificial intelligence for several reasons including: the methods disclosed herein focus on actual student learning, not a cat-and-mouse game of AI use and AI detection between students and instructors; AI detection is problematic because, by its very nature, AI generated material is continually evolving; even if AI detection were to work well, being presented with a “probability estimate” of AI content is still not terribly useful for an instructor, leaving the instructor to have to decide what to do in response to what level of probability; and there is evidence that AI detection methods can be biased against non-native language speakers and other groups.

Integration of AI into analysis of an assignment submitted by a student in order to create a quiz based on the content of that submission is a practical technological advancement which improves the educational value of the assignment for both the student and the instructor. Unlike AI detectors which analyze assignments to provide a probability estimate that the assignment was written by AI, the novel application of AI proposed has immediate practical benefits for an instructor. An instructor presented with a “probability estimate” from an AI detector is faced with the challenging decision of when to act on an estimate (e.g. what level is suspiciously high?) and what to do if action is needed (e.g. confront a student?). The method disclosed herein avoids these problematic choices for an instructor. The method disclosed herein maintains the focus of assignments where it should be—on learning, not playing detective (e.g. potentially eroding trust between instructor and student). With current methods for AI detection, students may use generative AI to write assignments and instructors may use AI-based “AI detectors” to detect this. Unfortunately, this can result in humans being left out of the loop in education. Students do not learn and instructors are distracted from teaching. The methods disclosed herein put the focus on learning and keep humans in the loop in education.

In an example, a method can comprise creating and administering a quiz which tests a student's understanding of the content of a body of text which the student submitted for an assignment in order to ensure that the student knows the content even if the student has used a machine process (e.g. generative AI) to help write the body of text. In an example, a method which measures a person's knowledge of content in a body of text submitted for an assignment can be a more accurate method of authenticating authorship than AI detection software and can also help to maintain the focus on actual learning (not an academic detective game).

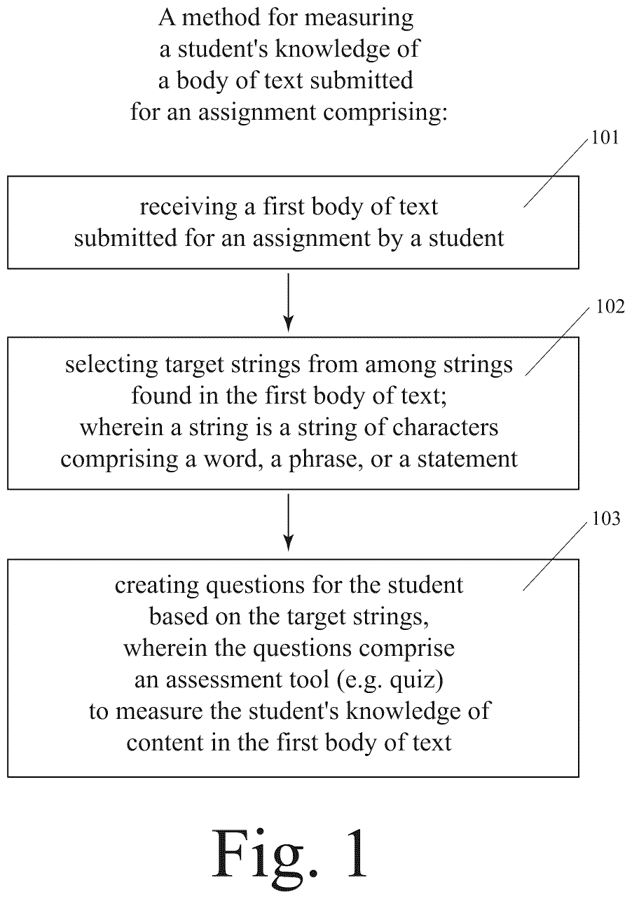

FIG. 1 shows steps for a method for measuring a student's knowledge of a body of text submitted for an assignment comprising: receiving a first body of text submitted for an assignment by a student 101; selecting target strings from among strings found in the first body of text, wherein a string is a string of characters comprising a word, a phrase, or a statement 102; and creating questions for the student based on the target strings, wherein the questions comprise an assessment tool to measure the student's knowledge of content in the first body of text 103.

In an example, a method for measuring a student's knowledge of a body of text submitted for an assignment can comprise: receiving a body of text submitted for an assignment by a student; and creating questions for the student based on the body of text, wherein the questions comprise an assessment tool to measure the student's knowledge of content in the body of text.

In an example, a method can further comprise creating a question: (a) presenting the student with a plurality of strings; wherein a string is a string of characters comprising a word, a phrase, or a statement; and wherein one string in the plurality is in the body of text and the other strings in the plurality are not in the body of text; and (b) asking the student to select the string which is in the body of text. In an example, a method can further comprise creating a question: (a) presenting the student with a plurality of strings; wherein a string is a string of characters comprising a word, a phrase, or a statement; and wherein one string in the plurality is not in the body of text and the other strings in the plurality are in the body of text; and (b) asking the student to select the string which is not in the body of text. In an example, a method can further comprise creating a question: (a) presenting the student with a target string from the body of text with one or more words missing; wherein a string is a string of characters comprising a word, a phrase, or a statement; and (b) asking the student to select a string from among a plurality of alternative strings wherein insertion of the selected string for the one or more missing words gives the target string its original meaning in the body of text.

In an example, a method for measuring a student's knowledge of a body of text submitted for an assignment can comprise: receiving a first body of text submitted for an assignment by a student; selecting target strings from among strings found in the first body of text, wherein a string is a string of characters comprising a word, a phrase, or a statement; and creating questions for the student based on the target strings, wherein the questions comprise an assessment tool to measure the student's knowledge of content in the first body of text.

In an example, a method can further comprise selecting target strings at least partly based on the infrequency and/or rarity with which strings have previously been found in a second body of text, wherein the second body of text is at least three orders of magnitude larger than the first body of text, and wherein strings which are more infrequent and/or rare are more likely to be selected as target strings. In an example, a method can further comprise using a previously-created database containing data concerning the infrequency and/or rarity of strings to help select target strings. In an example, a method can further comprise using artificial intelligence or other machine assistance to evaluate the infrequency and/or rarity of strings to help select target strings.

In an example, a method can further comprise selecting target strings at least partly based on the vocabulary levels of one or more words in the strings and wherein strings with higher vocabulary levels are more likely to be selected as target strings. In an example, a method can further comprise using a previously-created database containing data concerning the vocabulary levels of strings to help select target strings. In an example, a method can further comprise using artificial intelligence or other machine assistance to evaluate the vocabulary levels of strings to help select target strings.

In an example, a method can further comprise selecting target strings at least partly based on the relevance, importance, and/or significance of the strings to the assignment and wherein strings with greater relevance, importance, and/or significance are more likely to be selected as target strings. In an example, a method can further comprise using artificial intelligence or other machine assistance to evaluate the relevance, importance, and/or significance of strings to help select target strings.

In an example, a method can further comprise creating questions which measure the student's understanding of the meanings of the target strings. In an example, a method can further comprise creating a question: (a) presenting the student with a target string; and (b) asking the student to select a string with a meaning which is closest to the meaning of the target string from among a plurality of alternative strings. In an example, a method can further comprise using a previously-created database concerning strings which are close in meaning to each other to help identify a string with a meaning close to the meaning of the target string. In an example, a method can further comprise using artificial intelligence or other machine assistance to identify a string with a meaning close to the meaning of the target string. In an example, a method can further comprise creating a question: (a) presenting the student with a target string from the first body of text with one or more words missing; and (b) asking the student to select a string from among a plurality of alternative strings wherein insertion of the selected string for the one or more missing words gives the target string its original meaning in the first body of text.

In an example, a method can further comprise using artificial intelligence or other machine assistance to create a question: (a) presenting the student with a target string; and (b) asking the student to select a string from among a plurality of alternative strings which is consistent with, agrees with, and/or supports the target string. In an example, a method can further comprise using artificial intelligence or other machine assistance to create a question: (a) presenting the student with a target string; and (b) asking the student to select a string from among a plurality of alternative strings which is inconsistent with, disagrees with, and/or does not support the target string.

In an example, a method for testing a person's understanding of a body of text can comprise:
(a) receiving a body of text (e.g. an essay or other assignment) with at least 300 words from a person (e.g. a student); (b) prompting a machine process (e.g. artificial intelligence) to identify a first set (e.g. with between 5 and 30 members) of key (e.g. significant or important) character strings (e.g. with lengths between 5 and 100 characters) in the body of text; (c) prompting a machine process (e.g. artificial intelligence) to create a second set of character strings, wherein for each string in the first set there is a corresponding string in the second set with different word(s) but the same meaning as the string in the first set; (d) create a quiz or test which, for each string in the first set: presents the person with a string from the first set; presents the person with a (randomized order) list of alternative strings, wherein the list of alternative strings includes the corresponding string in the second set with the same meaning as the string in the first set; and asks the person to select the corresponding string from the second set.

In an example, a body of text submitted by a student for an assignment can be entered through a school's learning management system. In another example, a method, process, or system for measuring a student's understanding of a body of text submitted by the student for an assignment can be integrated with a school's learning management system. As another embodiment, a method for testing a person's understanding of a submitted body of text can comprise creating and administering a quiz with 5 to 20 multiple choice questions based on the content of the submitted body of text. In an example, a quiz can be administered in person (e.g. in a paper format). In another example, a quiz or quiz can comprise between 4 and 40 questions, wherein each question presents a statement made in the body of text.

In an example, a method can automatically select target strings (e.g. words or phrases) from a submitted body of text whose rarity scores which are above a selected percentile of all strings (e.g. words or phrases) in the text. In another example, a method can include ranking strings (e.g. words or phrases) from a body of text in decreasing order of rarity scores and selecting target strings in this descending order (starting at the top and working down in rarity scores) until a selected percentage of target strings has been selected for inclusion in a quiz. In an example, a sentence can be selected from a body of text based on average rarity score of words in the sentence (e.g. higher score for strings used less often in a large corpus of text). In an example, rarity scores for strings (e.g. words or phrases) can updated (e.g. in an iterative and/or Bayesian manner) based on the results from new quizzes created by this method.

In an example, a character string (e.g. word or phrase) can be selected from a body of text based on rarity score for string as found in a phrase database. As another embodiment, a phrase synonym database can contain a rarity score for each target string (e.g. word or phrase) in the database and for each synonym (e.g. string with a similar meaning) for the that target string. In an example, a sentence can be selected from a body of text based on infrequency of strings (e.g. words or phrases) in the sentence and in a phrase database, wherein frequency is frequency of use in a large corpus of text. In another example, rarity scores for strings (e.g. words or phrases) in a phrase synonym database can be updated based on a growing corpus of text which includes new submissions of bodies of text for review.

In an example, a character string (e.g. word or phrase) can be selected from a body of text based on infrequency of the string being previously found (e.g. in a large corpus of text). In another example, a method can automatically select target strings (e.g. words or phrases) from a submitted body of text whose usage frequencies in a large corpus of written material are below a selected percentile (X %) of usage frequencies. In an example, a sentence can be selected from a body of text based on infrequency of words in the sentence as previously found in a large corpus of text.

In an example, a character string (e.g. word or phrase) can be selected from a body of text based on string selected by AI in response to a prompt asking for selection of most unusual (e.g. least commonly found) string(s) in the body of text. As another embodiment, a sentence can be selected from a body of text based on rarity of strings (e.g. words or phrases) in the sentence as evaluated by AI which are also in a phrase database. In an example, target strings (e.g. words or phrases) can be selected from a body of text, at least in part, based on the frequency of those strings appearing in a cumulative corpus of machine-generated text, wherein strings which appear more frequently in the machine-generated text are more likely to be selected as target strings.

In an example, a method can include selecting target strings from a body of text (submitted by a student for an assignment) at least partly based on the vocabulary levels of one or more words in the strings, wherein strings with higher vocabulary levels are more likely to be selected as target strings. In another example, a sentence can be selected from a body of text based on vocabulary level of the highest-vocabulary-level word in the sentence. In an example, the vocabulary level assigned to a word can be based on how many words (e.g. 5,000, 20,000, 30,000, or 70,000) a person generally must use to understand the meaning of that word.

In an example, a character string (e.g. word or phrase) can be selected from a body of text based on vocabulary level of the highest-vocabulary-level word in the string which is also in a phrase database. In an example, a sentence can be selected from a body of text based on vocabulary level of the highest-vocabulary-level string (e.g. word or phrase) in the sentence which is also in a phrase database. In an example, a sentence can be selected from a body of text based on average length of strings (e.g. words or phrases) in the sentence which are also found in a phrase database. In an example, a sentence can be selected from a body of text based on length of the longest word in the sentence. In an example, a character string (e.g. word or phrase) can be selected from a body of text based on the number of synonyms for the string found in a phrase synonym database.

In an example, a method for testing a person's understanding of a body of text can comprise:

(a) receiving a body of text (e.g. a written assignment) submitted by a person; (b) scanning the body of text to select a first set of character strings (e.g. words or phrases) from the body of text, wherein a selected character string is found between spaces in the body of text, and wherein a selected character string is also found in a phrase synonym database; (c) selecting a second set of strings which is a subset of the first set of strings, wherein strings in the second set are selected based on one or more string attributes selected from the group consisting of: higher rarity scores in the phrase database, less-commonly used in a large corpus of text, less-commonly used as evaluated by machine (e.g. AI), higher word(s) vocabulary level, and longer word(s); and (d) for each string sequentially selected from the second string (herein called a target string), creating a question which presents the person with the target string, presents the person with a synonym for the target string extracted from the phrase synonym database and a plurality of non-synonym strings (e.g. in randomized order), and asks the person to select the synonym.

In an example, a character string (e.g. word or phrase) can be selected from a body of text based on string (e.g. word or phrase) is found in a phrase database. In an example, a method for testing a person's understanding of a submitted body of text can comprise creating and administering a quiz with multiple choice questions based on target strings (e.g. words or phrases) selected from the submitted body of text, wherein the target strings are selected based on their being found in a phrase synonym database. In another example, a sentence can be selected from a body of text based on number of words in the sentence which are also found in a phrase database.

In an example, a character string (e.g. word or phrase) can be selected from a body of text based on the number of words which it has in common with an assignment description and/or instructions. In another example, a method for measuring a student's understanding of a body of text submitted by the student for an assignment can comprise selecting target words, phrases, or statements from the body of text which are particularly relevant to the assignment instructions. In an example, a method for measuring a student's understanding of the content of a body of text which the student submitted for an assignment can comprise asking the student to select (and/or elaborate on) the most important statements (or points) made in the body of text. In an example, a sentence can be selected from a body of text based on number of words in common with an assignment description and/or instructions.

In an example, a character string (e.g. word or phrase) can be selected from a body of text based on level of string importance as evaluated by AI. As another embodiment, a method can comprise using a machine-learning (e.g. artificial intelligence) process to: search through a body of text submitted by a student for an assignment in order to identify statements, passages, and/or phrases which are particularly relevant to the topic (e.g. the instruction) for the assignment; and generate a quiz for the student to take which measures understanding of the material in those statements, passages, and/or phrases. In an example, a method for measuring a student's understanding of a body of text submitted by the student for an assignment can comprise using a machine process (e.g. artificial intelligence) to: select target words, phrases, or statements from the body of text which are particularly relevant to the assignment instructions; and create a quiz for the student to take which tests understanding of the meanings of those words, phrases, or statements.

In an example, a sentence can be selected from a body of text based on level of relevance of the sentence to the topic of the body of text (e.g. assignment description) as evaluated by AI. In an example, a sentence can be selected from a body of text based on sentence selected by AI in response to prompt asking for selection of sentence(s) in the body of text which are most relevant to the topic (e.g. assignment description). In another example, one or more (target) statements can be selected from a body of text by a machine (e.g. artificial intelligence). In an example, a sentence can be selected from a body of text based on opening sentence of the body of text. In another example, a character string (e.g. word or phrase) can be selected from a body of text based on string selected by AI in response to a prompt asking for selection of most controversial string(s) in the body of text. In an example, a sentence can be selected from a body of text based on sentence whose person point of view (e.g. first person vs. third person) changes and/or differs from other parts of the body of text.

In an example, a character string (e.g. word or phrase) can be selected as a target string based on one or more of the following attributes: inclusion of the string in a phrase synonym database; commonality (e.g. how commonly the string is found in a large corpus of text); rarity score (e.g. how rarely the string is found in a large corpus of text); vocabulary level the highest-vocabulary-level word in the string; average vocabulary level or words in the string; character length of the string; character length of the longest word in the string; and average character length of words in the string. In an example, a target string (e.g. word or phrase) in a statement can be the string which is least common in use, most rare in use, or highest in vocabulary level.

In an example, the number of target strings from a body of text which are selected from inclusion in a quiz can be based on one or more criteria selected from the group consisting of: number of characters or words in the submitted body of text; average length of words in the submitted body of text; longest word in the submitted body of text; average vocabulary level of words in the submitted body of text; and word with the highest vocabulary level in the submitted body of text; predetermined selected number of strings in first set regardless of the attributes of the body of text. In an example, when there are multiple possible string synonyms for a target string, then the string synonym with the lowest rarity score, the lowest vocabulary level, or the shortest length words can be selected as the correct answer in a quiz question concerning the target string.

In an example, a method for testing a person's understanding of a body of text can comprise:
(a) receiving a body of text (e.g. an assignment) on a given topic from a person (e.g. a student); (b) selecting a target statement (e.g. a sentence) made in the body of text; (c) identifying other statements on the same topic which were not made in the body of text; (d) creating a quiz which presents the person with the target statement and the other statements, wherein the person is asked to select the target statement. In another example, a method for testing a person's understanding of a body of text can comprise: (a) selecting a first set of statements (e.g. a sentences) made in a body of text; (b) identifying a second statement which was not made in the body of text; (c) presenting a person with the first set of statements and the second statement; and (d) asking the person to identify the second statement. As another embodiment, a method can include using (e.g. prompting) AI to create a question: (a) presenting a student with a plurality of strings; wherein a string is a string of characters comprising a word, a phrase, or a statement; and wherein one string in the plurality is not in a body of text (submitted by the student for an assignment) and the other strings in the plurality are in the body of text; and (b) asking the student to select the string which is not in the body of text.

In an example, a method for testing a person's understanding of a body of text can comprise:
(a) receiving a body of text (e.g. an assignment) on a given topic from a person (e.g. a student); (b) prompting a machine (e.g. artificial intelligence) to select a plurality of target statements (e.g. sentences) made in the body of text; (c) prompting the machine to identify, for each target statement, a plurality of other statements on the same topic which were not made in the body of text;
(d) creating a quiz which presents the person, for each target statement, the target statement and a plurality of other statements, and asking the person to select the target statement. In an example, a person can be given a multiple-choice question wherein one answer is a statement made in a body of text which they submitted for an assignment and other answers are other statements which are not in the body of text, wherein the other statements are generated by a machine (e.g. artificial intelligence), and wherein the person is asked to select the statement made in the body of text. In another example, a method for testing a person's understanding of a body of text can comprise a multiple-choice fill-in-the blank question based on one or more statements made in the body of text.

In an example, a method for testing a person's understanding of a body of text can comprise:
(a) receiving a body of text (e.g. an essay or other assignment) from a person (e.g. a student); (b) selecting a key statement (e.g. a sentence) from the body of text; (c) creating an incomplete version of the key statement by omitting (e.g. replacing with a blank) a first character string in the key statement; (d) presenting the person with the incomplete version of the statement and a plurality of alternative character strings from which one string can be selected to fill in the omitted part of the incomplete version, wherein one of the alternative character strings is the first character string; and
(e) asking the person to select the first character string from among the alternative character strings.

In an example, a method for testing a person's understanding of a body of text can comprise:
(a) selecting a statement (e.g. a sentence) made in a body of text; (b) selecting a target string (e.g. word or phrase) within the selected statement; (c) presenting a person with the statement with the target string omitted (e.g. replaced by a blank line); (d) presenting the person with a plurality (e.g. list) of strings which includes the target string and other strings (e.g. in a randomized order); and (e) then asking the person to select the target string so as to complete the statement made in the body of text.

In an example, a method for testing a person's understanding of a body of text can comprise:
(a) selecting a statement from a body of text (e.g. an assignment) submitted by a person (e.g. a student); (b) selecting a target character string (e.g. word or phrase) in the statement; (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is a synonym for (e.g. has virtually the same meaning as) the target character string; and (e) asking the person to select the character string in the plurality of character strings which, when inserted into the incomplete version, creates a statement which has the same meaning as the statement originally in the body of text.

In an example, a method for testing a person's understanding of a body of text can comprise:
(a) receiving a body of text (e.g. an essay or other assignment) from a person (e.g. a student); (b) scanning characters in the body of text (in a sequential manner) to identify key character strings which are found in a synonym database; (c) selecting a statement (e.g. a sentence) from the body of text which includes one of the key character strings, wherein the key character string in the selected statement can be called the first character string; (d) creating an incomplete version of the selected statement by omitting (e.g. replacing with a blank) the first character string in the selected statement; (e) presenting the person with the incomplete version of the statement and a plurality of second character strings from which one string can be selected to fill in the omitted part of the incomplete version, wherein one of the second character strings is a synonym for the first character string which is identified in the phrase synonym database, and wherein the rest of the second character strings are not synonyms for the first character string identified in the phrase synonym database; and (f) asking the person to select the second character string (e.g. the synonym) which changes the incomplete version into a statement with the same meaning as the selected statement in the body of text.

In an example, a method for testing a person's understanding of a body of text can comprise:
(a) receiving a body of text from a person; (b) identifying key character strings in the body of text which are found in a synonym database; (c) selecting a statement (e.g. a sentence) from the body of text which includes one of the key character strings, wherein the key character string in the selected statement can be called the first character string; (d) creating an incomplete version of the selected statement by omitting (e.g. replacing with a blank) the first character string in the selected statement; (e) presenting the person with the incomplete version of the statement and a plurality of second character strings from which one string can be selected to fill in the omitted part of the incomplete version, wherein one of the second character strings is a synonym for the first character string which is identified in the phrase synonym database; and (f) asking the person to select the second character string (e.g. the synonym) which changes the incomplete version into a statement with the same meaning as the selected statement in the body of text.

In an example, a method can include using (e.g. prompting) AI to create a question: (a) presenting a student with a target string from a body of text (submitted by the student for an assignment) with one or more words missing; wherein a string is a string of characters comprising a word, a phrase, or a statement; and (b) asking the student to select a string from among a plurality of alternative strings wherein insertion of the selected string for the one or more missing words gives the target string its original meaning in the body of text.

In an example, a method for testing a person's understanding of a body of text can comprise:
(a) prompting AI to select a key (e.g. important or significant) statement from a body of text (e.g. an assignment) submitted by a person (e.g. a student); (b) prompting AI to select a target character string (e.g. word or phrase) in the statement; (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is the target character string; and (e) asking the person to select the character string in the plurality of character strings which, when inserted into the incomplete version, restores the incomplete version to the statement originally in the body of text.

In an example, a method for testing a student's understanding of a body of text submitted for an assignment can comprise a multiple-choice fill-in-the blank question based on one or more statements made in the body of text, wherein the statements are selected by prompting a machine (e.g. artificial intelligence) to select the statements in the body of text which are most relevant to the title of the assignment. In another example, a method for testing a person's understanding of a body of text can comprise: (a) selecting the first sentences of a plurality of paragraphs in a body of text in the order in which they appear; (b) presenting the statements to a person in a randomized order; and (c) asking the person to reorder the statements into the order in which they appeared in the body of text.

In an example, a method for testing a person's understanding of a body of text can comprise:
(a) receiving a body of text (e.g. an assignment) submitted by a person (e.g. a student); (b) scanning the body of text character-by-character to identify a set of key character strings (e.g. word or phrases) used in the body of text, wherein if the sequential character is a space then the method scans forward a selected number of characters to search for strings and then returns to the sequential character before progressing to the next sequential character; (c) sequentially selecting strings from the set, wherein a string from the set which is selected at a specific time can be labeled the target string; (d) for each target string: identifying a synonym string (e.g. word or phrase) which is a synonym for the target string (e.g. has a similar meaning as the target string), identifying a plurality of other strings which are not synonyms for the target string (or at least are not selected as synonyms); presenting the person with the target string; presenting the person with the synonym string and the plurality of other strings (e.g. in randomized order); and asking the person to select the synonym string.

In an example, a method for testing a person's understanding of a body of text can comprise: extracting a target statement from a body of text (e.g. an assignment) which has been submitted by a person (e.g. a student); presenting the person with the target statement and a plurality of other statements, wherein only one of the other statements has the same meaning as the target statement; and asking the person to select the other statement with the same meaning as the target statement. In an example, a question can ask person (e.g. a student) to select (e.g. multiple choice) which of a list of strings (e.g. words or phrases) has a meaning which is most similar to the meaning of a target string, wherein the target string is selected from a submitted body of text (e.g. an assignment). One way to test a student's understanding of content in a body of text which the student submits is to measure whether the student can select strings (e.g. words or phrases) which have the same meanings as target strings (e.g. words or phrases) selected from the body of text.

In an example, a method for testing a person's understanding of a body of text can use a phrase synonym database to identify synonym strings for target strings found in the body of text. In an example, a phrase synonym database can be a general database (e.g. spanning all fields, subjects, or topics). In another example, a phrase synonym database can have variable length records, wherein each record has: a field for a target string (e.g. word or phrase); a field for a rarity score for the target string; one or more fields for synonyms for the target string (e.g. strings with the same or similar meaning to the target string; and one or more fields for rarity scores for the synonyms. In an example, a raw phrase synonym database can be created by a machine (e.g. artificial intelligence), this raw phrase synonym database can be reviewed and corrected by humans to create a final phrase synonym database, and then the final phrase synonym database can be used identifying target (e.g. key) strings in a body of text and/or synonyms for those strings.

In an example, a method for testing a person's understanding of a body of text can comprise:
(a) receiving a body of text (e.g. an assignment) submitted by a person (e.g. a student); (b) prompting a machine (e.g. artificial intelligence) to identify a first set of statements (e.g. facts or assertions) written in the body of text; (c) prompting a machine (e.g. artificial intelligence) to create a second set of statements wherein there is a statement in the second set corresponding to each statement in the first set having the same meaning as the statement in the first set; and (d) creating a quiz which asks the person a question for each statement in the first set (referred to as a target statement), wherein each question presents the person with a target statement from the first set, a statement from the second set corresponding to the target statement, and a plurality of other statements from the second set (e.g. in a randomized order); and (e) asking the person to select the statement from the second set which corresponds to (e.g. has the same meaning as) the target statement.

In an example, a multiple-choice question can present a person with a target string (e.g. word or phrase) selected from a body of text and a plurality of other strings, and then give the person a multiple-choice question asking them to identify the other string with the most similar meaning to that of the target string, wherein the other string with the most similar meaning is identified by a machine (e.g. artificial intelligence). In another example, a synonym for a target string (e.g. word or phrase) can be generated by a machine (e.g. artificial intelligence).

In an example, a method for testing a person's understanding of a body of text can comprise: extracting a target statement from a body of text (e.g. an assignment) which has been submitted by a person (e.g. a student); presenting the person with the target statement and a plurality of other statements, wherein only one of the other statements agrees with (e.g. is consistent with) the target statement; and asking the person to select the other statement which agrees with (e.g. is consistent with) the target statement. In an example, generative AI can be used to generate a multiple-choice quiz based on a body of text submitted by a student for an assignment and administer the quiz to the student online, wherein questions in the quiz present the student with selected statements made in the body of text and ask the student to select other statements which are consistent (or, alternatively, inconsistent) with the selected statements, and wherein statements which are particularly relevant to the topic (or instructions) of the assignment are selected.

In an example, a method for measuring a student's understanding of a body of text which the student submitted for an assignment can comprise using a machine (e.g. artificial intelligence) to create a multiple-choice quiz which asks the student to differentiate statements which are in agreement (e.g. are consistent) with statements made in the body of text from among alternative statements which are not in agreement (e.g. are inconsistent) with statements made in the body of text.

In an example, a method for testing a person's understanding of a body of text can comprise:
(a) receiving a body of text (e.g. an assignment) submitted by a person (e.g. student); (b) prompting a machine (e.g. artificial intelligence) to identify a first set of statements (e.g. facts or assertions) written in the body of text; (c) prompting a machine (e.g. artificial intelligence) to create a second set of statements wherein each statement in the second set corresponds to and supports (e.g. agrees with) a statement in the first set; and (d) creating a quiz which asks the person a question for each statement in the first set, wherein the statement in the first set for a given question is called the target statement, and wherein each question presents the person with the target statement, the statement from the second set corresponding to the target statement, and a plurality of other statements from the second set; and (e) asking the person to select the statement from the second set corresponding to (e.g. supporting) the target statement.

In an example, a phrase synonym database includes target strings (e.g. words or phrases) and synonym strings (e.g. words or phrases) for those target strings. As another embodiment, strings (e.g. words or phrases) in a phrase synonym database can be grouped into sets of strings with substantially-equivalent meanings. In an example, a phrase synonym database can include a plurality of strings (e.g. words or phrases), wherein there is a record for each of these strings, and wherein a record for a string includes one or more of the following fields: one or more synonyms for the string (e.g. words or phrases with the same meaning as the string); a rarity score for the string (e.g. higher rarity score for strings which are seldom found in a large corpus of text); a vocabulary level the for string; the character length for the string; and a rarity score, vocabulary level, or character length for each of the synonyms. In an example, identification of a synonym for a target string can include consideration of the context in which the target string is used in a body of text.

In an example, a database of strings (e.g. words or phrases) which is used in a method to test a student's understanding of content in a body of text can be a field-specific, wherein a field is a field of study, a field of research, an academic discipline, a type of profession, and/or a news topic. In an example, a field-specific database can specific to a particular academic discipline (e.g. biology), professional field (e.g. accounting), topic type (e.g. horses), or prose modality (e.g. poetry). In another example, selection of target strings (e.g. words or phrases) into the first set can be done using a field-specific phrase synonym database.

In an example, a method for extracting information from a body of text (e.g. an assignment) submitted by a person (e.g. a student) can include sequentially scanning characters in the body of text and converting quotation marks into spaces before scanning the body of text to select key statements, strings, word, or phrases. In an example, a method for testing a person's (e.g. student's) understanding of a body of text (e.g. submitted assignment) can comprise scanning through character positions in the body of text to identify target strings (e.g. words or phrases) and then asking the person (e.g. student) questions about the target string, wherein a question asks the person to the target string from a list which includes alternative strings which were not in the body of text.

In an example, a method for testing a person's understanding of a body of text can using a machine (e.g. artificial intelligence) to scan through sequential character positions in a submitted body of text (e.g. with over 1,000 characters) and then, for each character position, scanning a selected number or range (e.g. 100) of subsequent characters to identify target strings (e.g. words or phrases) which are also in a synonym database (e.g. wherein the database contains over 20,000 strings and at least one synonym for each string).

In an example, a body of text can be processed using one or more text-processing actions selected from the following group of actions: using optical character recognition (OCR) to convert images to text, converting all characters to lower case characters, converting all characters to upper case characters, eliminating hyphens at the ends of text lines, replacing all punctuation marks with spaces, replacing colons with spaces, replacing commas with spaces, replacing exclamation marks with spaces, replacing hyphens with spaces, replacing parentheses with spaces, replacing periods with spaces, replacing question marks with spaces, replacing quote marks with spaces, replacing semicolons with spaces, replacing stings comprising multiple contiguous spaces with single spaces, and replacing multi-space gaps with single spaces. As another embodiment, a method for testing a person's understanding of a body of text can comprise: scanning sequentially through character positions in a submitted body of text to find a first end-of-sentence punctuation mark (e.g. a period), scanning past that to find a second end-of-sentence punctuation mark (e.g. period), and then extracting the character string between the first and second punctuation marks as a statement.

In an example, a method for testing a person's understanding of a body of text can comprise:
(a) receiving a body of text (e.g. a written assignment) submitted by a person (e.g. student); (b) prompting a machine (e.g. artificial intelligence) to create a quiz comprising a plurality of multiple-choice questions with correct answers based on content in the body of text, wherein the quiz is administered online, and wherein a fixed amount of time is given for each question to select the correct answer. In an example, questions in a quiz can be timed, wherein a student is allowed a selected maximum amount of time to select an answer for each question.

In an example, a person can select an answer to a question in an online multiple-choice quiz by one or more of the following actions: checking a box next to an answer on a screen, clicking on an answer on a screen, directing a cursor or pointer over an answer on a screen, hovering a cursor or pointer over an answer on a screen, looking at an answer (with eye tracking), making a hand gesture which is associated with an answer or a label corresponding to an answer, speaking an answer or a label corresponding to an answer, swiping an answer on a touch-screen, and using a keyboard or keypad to enter an answer or a label corresponding to an answer.

In an example, a machine-learning process (e.g. artificial intelligence) can be used to create a quiz (e.g. a multiple-choice) which tests a student's knowledge of content in a body of text which the student submitted for an assignment. In another example, a method for testing a person's understanding of a submitted body of text can comprise creating and administering a quiz with multiple choice questions based on target strings (e.g. words or phrases) selected from the submitted body of text, wherein the target strings are selected by a machine (e.g. artificial intelligence). In an example, generative AI can be used to: generate a multiple-choice quiz based on a body of text submitted by a student for an assignment; and administer the quiz to the student online. In an example, a machine (e.g. artificial intelligence) can be prompted to select set of statements from a body of text submitted by a person, wherein questions concerning these statements test the person's understanding of these statements. The novel and practical application of AI disclosed herein helps students and faculty to focus on learning rather than wind up in a cat-and-mouse game of AI-written assignments and AI-writing detection.

In an example, a method for testing a student's understanding of content in a body of text which the student submitted for an assignment can comprise using a generative pre-trained transformer process, agent, and/or system to perform one or more of the following steps: evaluating the rarity or vocabulary level of target strings (e.g. words or phrases); identifying string synonyms for (e.g. words or phrases with the same meaning as) target strings; identifying the most important words, phrase, and/or statements in the body of text; identifying the primary field of a body of text (e.g. for selection of a field-specific database); identifying the words, phrases, and/or statements in the body of text which are most relevant to the assignment topic or instructions; scanning the body of text to identify target strings (e.g. words or phrases); selecting a subset of target strings for inclusion in a quiz to test the student's understanding; and selecting word or phrases in the body of text which are most unusual, most rare, or having the highest vocabulary levels.

In an example, a method for measuring a student's understanding of a body of text which the student submits for an assignment can be embodied a machine-generated (e.g. artificial intelligence) interactive session of questions and answers. As another embodiment, a method for testing a student's understanding of a body of text submitted by the student for an assignment can include modifying subsequent questions in a quiz based on the student's answers to previous questions. In an example, a method for using a multiple-choice quiz to test a student's understanding of a body of text submitted by the student for an assignment can include modifying (e.g. in real time) subsequent questions in the quiz based on the student's answers to previous questions, wherein the difficulty level of subsequent questions is increased when the student selects more correct answers in previous questions and the difficulty level of subsequent questions is decreased when the student selected fewer correct answer in previous questions. In an example, a student's performance on past quizzes can be one of the factors used to generate a current quiz to test the students understanding of a body of text which the student has submitted for an assignment.

In an example, a body of text received as part of this method can be directly submitted and/or uploaded by a person asserting authorship of the text and a resulting quiz can be administered online. In an example, a body of text to be analyzed by this method can be submitted in selected format (e.g. as a word processing file). In another example, a method can be embodied in executable commands and/or instructions which are stored in a computer hard disk, a computer-readable optical medium, a RAM, and/or a PROM. In an example, a method can be implemented in a network of data processing systems. In another example, a method can be implemented on a web server. In an example, a method can be implemented via a computer network. In an example, a method can be implemented within computer hardware, a data processor, a data processing unit, and/or a computer-readable medium.

In an example, a body of text submitted by a student for an assignment can be entered into software. In an example, a method can be embodied in (e.g. be embodied, implemented, and/or stored) in source code, interpretive code, object code, and/or directly executable code. In an example, a method can be implemented in a computer readable medium that contains, stores, communicates, or transports a set of executable commands and actionable files. In another example, a method can be implemented in software written with a programming language. In an example, a method can be stored, implemented, and/or executed in computer readable media. In another example, a method for testing a student's understanding of the content of a body of text which the student submits for an assignment can be embodied in a non-transitory computer readable medium. In an example, a (character) string can be a sequence of characters between 3 and 100 characters long which comprises a word, a phrase, or a statement.

In an example, a body of text can be an assignment which is submitted by a student for a course. In an example, a database selected for use in a method for measuring a student's understanding of a body of text can be selected based on identification of the body of text being of one the following types: biographic profile, blog entry, book report, business analysis, case study analysis, composition, discussion post, dissertation, editorial, editorial piece, email, essay, financial analysis, financial valuation, grant proposal, journal article, journal article review, lab report, legal brief, letter, literature review, magazine article, marketing plan, master's thesis, medical notes, movie review, news article, novel, patent application, performance review, pitch deck, play, poem, public speech, real property description, report, research paper, resume or CV, screen play, short story, slide show, song lyrics, strategic plan, SWOT analysis, and valuation analysis.

It would be very laborious (and likely impractical) for an instructor to manually scan (e.g. character-by-character) a body of text which a student submits for an assignment submission in order to identify target strings (e.g. words or phrases), then identify synonym strings for those target strings, then identify non-synonym strings, then present the student with a quiz listing the target strings, each of which is accompanied by a synonym string and other strings (in random order), and then ask the student to select the synonym string for each.

Integrating AI into a school's learning management system enables automatic creation and administration of a quiz which tests the student's understanding of core statements and/or concepts expressed in an assignment which the student submitted. This keeps the focus of education on learning, not a cat-and-mouse game of AI detection between a student and an instructor. There are several problems with current methods for AI detection. First, AI-generated content is an evolving and moving target. By definition, generative AI systems learn and evolve. Word patterns which an AI detector may use to detect AI-generated content today can be gone tomorrow. Second, even if AI were not learning and evolving, students can become increasingly sophisticated in formulating AI prompts (and using multiple text-processing methods in succession) to avoid flagging by AI detectors. Third, AI detectors can be biased against certain writing styles and demographic groups, such as non-native-language speakers. The methods disclosed herein help to solve these problems and comprise a significant technological improvement over current methods.

A central premise of the methods disclosed herein is that students should understand what they submit for an assignment, regardless of the extent to which they use machine assistance (e.g. artificial intelligence) for help. If a student understands the content of what they submit, then a quiz based on the content of that submission should be easy to take. If a student uses AI to write their assignment submission and does not have a clue about what it says, then they may not be able to do well in a quiz based on the content of what they submitted. In an example, a method can include creating questions which measure a student's understanding of the meanings of target strings selected from a body of text which the student submitted for an assignment. The integration of AI into a learning management system to create a quiz which tests a student's understand of the body of text which they submitted for an assignment is a substantive technological improvement over the functionality of current learning management systems.

In an example, a method for testing a person's understanding of a body of text can comprise:
(a) receiving a body of text (e.g. an essay or other assignment) with at least 300 words from a person (e.g. a student); (b) scanning characters in the body of text (in a sequential manner) to identify key character strings (with lengths between 5 and 100 characters) which are found in a synonym database containing at least 10,000 records; (c) selecting a statement (e.g. a sentence) from the body of text which includes one of the key character strings, wherein the key character string in the selected statement can be called the first character string; (d) creating an incomplete version of the selected statement by omitting (e.g. replacing with a blank) the first character string in the selected statement; (e) presenting the person with the incomplete version of the statement and a plurality of second character strings from which one string can be selected to fill in the omitted part of the incomplete version, wherein one of the second character strings is a synonym for the first character string which is identified in the phrase synonym database, and wherein the rest of the second character strings are not synonyms for the first character string identified in the phrase synonym database; and (f) asking the person to select the second character string (e.g. the synonym) which changes the incomplete version into a statement with the same meaning as the selected statement in the body of text.

In an example, a method for measuring a student's knowledge and/or understanding of a body of text submitted for an assignment can comprise: receiving a body of text submitted for an assignment by a student; and creating questions for the student based on the body of text, wherein the questions comprise an assessment tool (e.g. quiz) to measure the student's knowledge of content in the body of text. In an example, a method for testing a person's understanding of a submitted body of text can comprise creating and administering a quiz with multiple choice questions based on target strings (e.g. words or phrases) selected from the submitted body of text. In an example, a quiz can be administered remotely (e.g. online via the internet). In another example, a body of text submitted by a student for an assignment can be uploaded through a school's learning management system.

In an example, a character string (e.g. word or phrase) can be selected from a body of text based on rarity score of the most infrequent (most rare and/or least commonly used) word in the string. In another example, a method can comprise: automatically selecting relatively-rare target strings (e.g. words or phrases) used in a submitted body of text which is asserted to have been written by a specific person; and creating a quiz to measure the person's understanding of those target strings (e.g. words or phrases) which is administered to the person. In an example, a rarity score assigned to a string (e.g. word or phrase) can be an inverse (or negative) function of the number (or percentage) of people (e.g. students) who know the meaning of the string (e.g. based on cumulative previous quiz results). In another example, a sentence can be selected from a body of text based on rarity score of the most infrequent (most rare and/or least commonly used) word in the sentence. In an example, software for a method can: automatically scan through a body of text to identify strings (e.g. words or phrases); and automatically assign a rarity score to each identified string.

In an example, a method can include using a previously-created database containing data concerning the infrequency and/or rarity of strings to help select target strings from a body of text submitted by a student for an assignment. As another embodiment, a rarity score can be assigned to a character string (e.g. word or phrase) and stored in a database. In an example, a sentence can be selected from a body of text based on rarity score of the most infrequent string (e.g. word or phrase) in the sentence which is also in a phrase database. In an example, rarity scores for strings (e.g. words or phrases) in a phrase synonym database can be updated based on the content of newly-submitted bodies of text.

In an example, a character string (e.g. word or phrase) can be selected from a body of text based on rarity score of the string (e.g. higher score for strings used less often in a large corpus of text). In another example, a method can include selecting target strings from a first body of text at least partly based on the infrequency and/or rarity with which strings have previously been found in a second body of text, wherein the first body of text was submitted by a student for an assignment, wherein the second body of text is at least three orders of magnitude larger than the first body of text, and wherein strings which are more infrequent and/or rare are more likely to be selected from the first body of text as target strings.

In an example, a string (e.g. word or phrase) can be assigned a rarity score based on one or more factors selected from the group consisting of: the frequency of usage of the string in a corpus of text written for (or by) people in the general population, the frequency of usage of the string in a corpus of text available on the internet, the frequency of usage of the string in a corpus of text written for (or by) people in specific field, the frequency of usage of the string in a corpus of text written for (or by) people in a specific demographic group, the frequency of usage of the string in a corpus of text written for (or by) people in a specific profession, the frequency of usage of the string in a corpus of text written for (or by) people at a specific educational level, the frequency of usage of the string in a corpus of text written for (or by) people with a specific native language, the frequency of usage of the string in a corpus of text written for (or by) people with a specific level of fluency in a language, the frequency of usage of the string in material previously written by the person who is asserted to be the author of a submitted body of text, the frequency of usage of the string in a corpus of text written by AI (e.g. machine generated material), the frequency of understanding of the meaning of the string in past testing (e.g. using this method), the educational level needed for a person to understand and/or use the string, the general vocabulary level needed for a person to understand and/or use the string, and the field-specific vocabulary level needed for a person to understand and/or use the string.

In an example, a method can include using artificial intelligence or other machine assistance to evaluate the infrequency and/or rarity of strings to help select target strings from a body of text submitted by a student for an assignment. In an example, a sentence can be selected from a body of text based on rarity of words in the sentence as evaluated by AI. In another example, a character string (e.g. word or phrase) can be selected from a body of text based on average vocabulary level of word(s) in the string. As another embodiment, a rarity score assigned to a string (e.g. word or phrase) can be based on the number of words in a vocabulary level (e.g. 5,000, 10,000, 30,000, or 70,000) at which the string is first generally understood. In an example, less-common or higher-vocabulary-level strings (e.g. words or phrases) can be selected from a body of text. In an example, when selecting a target string (e.g. word or phrase) among a plurality of target strings, if the vocabulary levels of the strings are not known, then (maximum) word length can be used as a proxy for vocabulary level and the target string with the longest (maximum) word length can be selected.

In an example, a method can include using a previously-created database containing data concerning the vocabulary levels of strings to help select target strings from a body of text submitted by a student for an assignment. In an example, a character string (e.g. word or phrase) can be selected from a body of text based on length of the longest word in the string. In another example, a sentence can be selected from a body of text based on average length of words in the sentence. In an example, when a method is selecting a synonym for a target string (e.g. word or phrase) and synonym with a vocabulary level which is lower than that of the target string will be selected. In another example, a method can include using a previously-created database concerning strings which are close in meaning to each other to help identify a string with a meaning close to the meaning of the target string from a body of text submitted by a student for an assignment.

In an example, a method for testing a person's understanding of a body of text can comprise:
(a) receiving a body of text (e.g. a written assignment) submitted by a person; (b) scanning the body of text to select a first set of character strings (e.g. words or phrases) from the body of text, wherein a selected character string is found between spaces in the body of text, and wherein a selected character string is also found in a phrase synonym database; (c) selecting a second set of strings which is a subset of the first set of strings, wherein strings in the second set are selected based on one or more string attributes selected from the group consisting of: higher rarity scores in the phrase database, less-commonly used in a large corpus of text, less-commonly used as evaluated by machine (e.g. AI), higher word(s) vocabulary level, and longer word(s); and (d) for each string sequentially selected from the second string (herein called a target string), creating a question which presents the person with the target string, presents the person with two or more synonym strings for the target string extracted from the phrase synonym database and a plurality of non-synonym strings (e.g. in randomized order), and asks the person to select the two or more string synonyms.

In an example, a method for testing a person's understanding of a body of text can comprise: scanning sequentially through character positions in a submitted body of text to find spaces; and then, for each space, scanning a length (or range) of characters after the space to identify target strings (e.g. words or phrases) which are also found in a phrase synonym database. As another embodiment, a sentence can be selected from a body of text based on number of strings (e.g. words or phrases) in common with an assignment description and/or instructions which are also in a phrase database. In an example, a sentence can be selected from a body of text based on string (word or phrase) in the sentence which is also found in a phrase database.

In an example, a character string (e.g. word or phrase) can be selected from a body of text based on the number of words which it has in common with the title of the body of text. In an example, a method for measuring a student's understanding of a body of text submitted by the student for an assignment can comprise: selecting target words, phrases, or statements from the body of text which are particularly relevant to the assignment instructions; and creating a quiz for the student to take which tests understanding of the meanings of those words, phrases, or statements.

In an example, a method for testing a person's understanding of a body of text can comprise:
(a) receiving a body of text submitted by a person; (b) scanning the body of text to select a plurality of statements (e.g. sentences) from the body of text; (c) presenting the plurality of statements to the person and asking them to pick which of them, in their opinion, is most important to the body of text; (d) selecting a character string from the statement which they pick (herein after referred to as a target string); (e) identifying a synonym for the target string; (f) presenting the person with the target string; (g) presenting the person with the synonym and a plurality of other words or phrases (e.g. in a randomized order); and (h) asking the person to select the synonym. In another example, a sentence can be selected from a body of text based on number of words in common with the title of the body of text.

In an example, a character string (e.g. word or phrase) can be selected from a body of text based on string selected by AI in response to a prompt asking for selection of important string(s) in the body of text. In another example, a method can include using artificial intelligence or other machine assistance to evaluate the relevance, importance, and/or significance of strings to a course assignment to help select target strings from a body of text submitted by a student for the assignment. In an example, a method for measuring a student's understanding of a body of text which the student submitted for an assignment can comprise using a machine (e.g. artificial intelligence) to create a multiple-choice quiz which asks the student to select (e.g. differentiate) important statements, issues, or points which were made in the body of text from among a plurality of alternative statements, issues, or points which were not made in the body of text. In another example, a sentence can be selected from a body of text based on level of sentence importance as evaluated by AI. As another embodiment, AI can be used to create a quiz which focused on the most important and/or relevant statements or phrases in an assignment submission in order to test (and reinforce) the student's understanding of the most important aspects of the assignment material.

In an example, a sentence can be selected from a body of text based on closing sentence of the body of text. In an example, a method for testing a person's understanding of a body of text can comprise: (a) receiving a body of text (e.g. assignment) with references submitted by a person (e.g. student); (b) identifying a reference (e.g. source) cited in the body of text; (c) identifying a target statement (e.g. sentence) associated with the cited reference in the body of text; (d) identifying a plurality of other statements (e.g. sentences) in the body of text which are not associated with the cited reference; (e) creating a question which presents the person with the reference citation, as well as the target statement and plurality of other statements (e.g. in a randomized order); and (f) asking the person to select the target statement which is associated with the cited reference. In an example, a character string (e.g. word or phrase) can be selected from a body of text based on string whose person point of view (e.g. first person vs. third person) changes and/or differs from other parts of the body of text.

In an example, a (target) character string (e.g. word or phrase) can be selected from a body of text (e.g. for use in a question to test understanding) based on one or more string attributes selected from the group consisting of the following: average vocabulary level of word(s) in the string; infrequency of the string being previously found (e.g. in a large corpus of text); length of the longest word in the string; length of the string; level of relevance of the string to the topic of the body of text (e.g. assignment description) as evaluated by AI; level of string importance as evaluated by AI; number of synonyms for the string found in a phrase synonym database; number of words in common with an assignment description and/or instructions; number of words in common with the title of the body of text; rarity of word(s) in the string as evaluated by AI; rarity score for string as found in a phrase database; rarity score of the most infrequent (most rare and/or least commonly used) word in the string; rarity score of the string (e.g. higher score for strings used less often in a large corpus of text); string (e.g. word or phrase) is found in a phrase database; string containing one or more words not found in a dictionary; string selected by AI in response to a prompt asking for selection of most controversial string(s) in the body of text; string selected by AI in response to a prompt asking for selection of string(s) in the body of text which are most relevant to the topic (e.g. assignment description); string selected by AI in response to a prompt asking for selection of important string(s) in the body of text; string selected by AI in response to a prompt asking for selection of most unusual (e.g. least commonly found) string(s) in the body of text; string whose person point of view (e.g. first person vs. third person) changes and/or differs from other parts of the body of text; vocabulary level of the highest-vocabulary-level word in the string which is also in a phrase database; and vocabulary level of the highest-vocabulary-level word in the string.

In an example, a subset of statements found in a body of text can be selected based on one or more criteria selected from the group consisting of: average rarity of words in a statement; most rare word in a statement; average vocabulary level of words in a statement; highest-vocabulary-level word in a statement; number of words in a statement; and position of a statement in a paragraph. In an example, one or more statements can be selected from a body of text based on one or more of the following attributes: average rarity score of words in the statement; rarity score of the most rare word in the statement; average vocabulary level of words in the statement; vocabulary level of the highest-vocabulary-level word in the statement; length of the statement; average length of words in the statement; length of longest word in the statement; and position of the statement in a paragraph.

In an example, the set of statements can be selected from the body of text based on one or more of the following attributes: high (average) rarity score of words in the statements; most rare words in the statements; highest (average) vocabulary level of words in the statements; position of statements in paragraphs; importance as evaluated by a machine process (e.g. artificial intelligence); and relevance to the topic of the body of text as evaluated by a machine process (e.g. artificial intelligence).

In an example, a method can include creating a question: (a) presenting a student with a plurality of strings; wherein a string is a string of characters comprising a word, a phrase, or a statement; and wherein one or more strings in the plurality are in a body of text submitted by the student for an assignment and the other strings in the plurality are not in the body of text; and (b) asking the student to select one or more strings which are in the body of text.

In an example, a method for testing a person's understanding of a body of text can comprise:
(a) receiving a first body of text (e.g. an assignment) on a given topic submitted by a person (e.g. a student); (b) receiving or creating a second body of text on the topic which has not been submitted by the person; (c) selecting a target statement (e.g. sentence) from the first body of text; (d) selecting a plurality of statements (e.g. sentences) from the second body of text; (e) creating a question which presents the person with the target statement and the plurality of statements from the second body of text, in randomized order, and asks the person to select the target sentence. In an example, a person can be given a multiple-choice question wherein one answer is a statement made in a body of text which they submitted for an assignment and other answers are statements which are not in the body of text, and wherein the person is asked to select the statement made in the body of text.

In an example, a method can include using (e.g. prompting) AI to: (a) present a student with a plurality of strings; wherein a string is a string of characters comprising a word, a phrase, or a statement; and wherein one string in the plurality is in a body of text (submitted by the student for an assignment) and the other strings in the plurality are not in the body of text; and (b) ask the student to select the string which is in the body of text. In an example, a method for testing a person's understanding of a body of text can comprise: (a) receiving a first body of text (e.g. an assignment) on a selected topic which has been submitted by a person (e.g. student); (b) prompting a machine (e.g. artificial intelligence) to compose a second body of text on the same topic; (c) selecting a first sentence from the first text; (d) selecting a plurality of second sentences from the second text; (e) creating a question which presents the person with the first sentence and the plurality of second sentences (e.g. in randomized order); and (f) asking the person to identify the first sentence.

In an example, a method can include creating a question: (a) presenting a student with a target string from a body of text with one or more words missing, wherein the student submitted the body of text for an assignment; and (b) asking the student to select a string from among a plurality of alternative strings, wherein insertion of the selected string for the one or more missing words restores the original meaning of the target string as in the body of text.

In an example, a method for testing a person's understanding of a body of text can comprise:
(a) receiving a body of text (e.g. an essay or other assignment) from a person (e.g. a student); (b) selecting a key statement (e.g. a sentence) from the body of text, wherein the key statement is selected based on one or more criteria selected from the group consisting of: first sentence of a paragraph; concluding sentence of the body of text; sentence containing two or more words from the title of the body of text; sentence containing two or more words from the description of an assignment for which the body of text is submitted; statement for which a source (e.g. reference note) is cited; average length of words in the statement; longest word in the statement; average vocabulary level of words in the statement; highest-vocabulary word in the statement; and key statement in the body of text identified by a machine (e.g. artificial intelligence); (c) creating an incomplete version of the key statement by omitting (e.g. replacing with a blank) a first character string in the key statement, wherein the first character string is selected based on one or more criteria selected from the group consisting of: contains two or more words from the title of the body of text; contains two or more words from the description of an assignment for which the body of text is submitted; average length of words in the string; longest word in the string; average vocabulary level of words in the string; highest-vocabulary word in the string; and key string in the statement as identified by a machine (e.g. artificial intelligence); (d) presenting the person with the incomplete version of the statement and a plurality of alternative character strings from which one string can be selected to fill in the omitted part of the incomplete version, wherein one of the alternative character strings is the first character string; and (e) asking the person to select the first character string from among the alternative character strings.

In an example, a method for testing a person's understanding of a body of text can comprise:
(a) receiving a body of text from a person; (b) selecting a sentence from the body of text; (c) creating an incomplete version of the sentence by omitting a first character string in the key statement; (d) presenting the person with the incomplete version of the statement and a plurality of alternative character strings from which one string can be selected to fill in the omitted part of the incomplete version, wherein one of the alternative character strings is the first character string; and
(e) asking the person to select the first character string from among the alternative character strings.

In an example, a method for testing a person's understanding of a body of text can comprise:
(a) selecting a statement from a body of text (e.g. an assignment) submitted by a person (e.g. a student), wherein the statement is selected based on one or more of the following statement attributes: lead sentence of a paragraph; opening or concluding sentence of the body of text; sentence for which a citation (e.g. reference or source) was noted; sentence with highest-vocabulary-level words; sentence with the greatest number of words in common with the instructions for the assignment for which the body of text was submitted; and sentence with the greatest number of words in common with title of the body of text; (b) selecting a target character string (e.g. word or phrase) in the statement; (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is the target character string; and (e) asking the person to select the character string in the plurality of character strings which, when inserted into the incomplete version, restores the incomplete version to the statement originally in the body of text.

In an example, a method for testing a person's understanding of a body of text can comprise:
(a) selecting a statement from a body of text (e.g. an assignment) submitted by a person (e.g. a student); (b) selecting a target character string (e.g. word or phrase) in the statement; (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is the target character string; and (e) asking the person to select the character string in the plurality of character strings which, when inserted into the incomplete version, restores the incomplete version to the statement originally in the body of text.

In an example, a method for testing a person's understanding of a body of text can comprise:
(a) receiving a body of text from a person; (b) identifying key character strings in the body of text which are also in a synonym database; (c) selecting a statement (e.g. sentence) from the body of text which includes one of the key character strings; (d) creating an incomplete version of the selected statement by omitting the key character string in the selected statement; (e) presenting the person with the incomplete version of the statement and a plurality of second character strings from which one string can be selected to fill in the omitted part of the incomplete version, wherein one of the second character strings is a synonym for the key character string in the statement extracted from in the phrase synonym database; and (f) asking the person to select the second character string which changes the incomplete version into a statement with the same meaning as the selected statement in the body of text.

In an example, a method for testing a person's understanding of a body of text can comprise:
(a) receiving a body of text from a person; (b) scanning the body of text to identify key character strings which are found in a synonym database; (c) selecting a statement (e.g. a sentence) from the body of text which includes one of the key character strings, wherein the key character string in the selected statement can be called the first character string; (d) creating an incomplete version of the selected statement by omitting (e.g. replacing with a blank) the first character string in the selected statement; (e) presenting the person with the incomplete version of the statement and a plurality of second character strings from which one string can be selected to fill in the omitted part of the incomplete version, wherein one of the second character strings is a synonym for the first character string which is identified in the phrase synonym database, and wherein the rest of the second character strings are not synonyms for the first character string identified in the phrase synonym database; and (f) asking the person to select the second character string (e.g. the synonym) which changes the incomplete version into a statement with the same meaning as the selected statement in the body of text.

In an example, a method can include using (e.g. prompting) AI to: (a) present a student with a target string from a body of text (submitted by the student for an assignment) with one or more words missing; wherein a string is a string of characters comprising a word, a phrase, or a statement; and (b) ask the student to select a string from among a plurality of alternative strings wherein insertion of the selected string for the one or more missing words gives the target string its original meaning in the body of text.

In an example, a method for testing a person's understanding of a body of text can comprise:
(a) selecting a statement from a body of text (e.g. an assignment) submitted by a person (e.g. a student); (b) selecting a target character string (e.g. word or phrase) in the statement; (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is a synonym for (e.g. has virtually the same meaning as) the target character string, and wherein the synonym is identified using AI; and (e) asking the person to select the character string in the plurality of character strings which, when inserted into the incomplete version, creates a statement which has the same meaning as the statement originally in the body of text. In an example, a method for testing a person's understanding of a body of text can comprise:
   (a) selecting a set of statements (e.g. a sentences) made in a body of text in the order in which they appear in the body of text; (b) presenting the set of statements to a person in a randomized order;
   and (c) asking the person to reorder the statements into the order in which they appeared in the body of text.

In an example, a method for testing a person's understanding of a body of text can comprise:
(a) receiving a body of text (e.g. an assignment) submitted by a person (e.g. a student); (b) scanning the body of text to identify a set of character strings (e.g. word or phrases) used in the body of text;
(c) sequentially selecting strings from the set, wherein a string from the set which is selected at a specific time can be labeled the target string; (d) for each target string: identifying a synonym string (e.g. word or phrase) which is a synonym for the target string (e.g. has a similar meaning as the target string), identifying a plurality of other strings which are not synonyms for the target string (or at least are not selected as synonyms); presenting the person with the target string; presenting the person with the synonym string and the plurality of other strings (e.g. in randomized order); and asking the person to select the synonym string.

In an example, a method can include creating a question: (a) presenting a student with a target string from a body of text submitted by the student for an assignment; and (b) asking the student to select a string whose meaning which is closest to the meaning of the target string from among a plurality of alternative strings. In an example, a multiple-choice question can present a person with a target string (e.g. word or phrase) selected from a body of text and a plurality of other strings, and then give the person a multiple-choice question asking them to identify the other string with the most similar meaning to that of the target string. In another example, a question can ask person to select (e.g. multiple choice) which of a list of strings (e.g. words or phrases) has a meaning which is most similar to the meaning of a target string.

In an example, a method for testing a person's understanding of a body of text can comprise:
(a) receiving a body of text (e.g. an assignment) submitted by a person (e.g. a student); (b) scanning the body of text character by character to identify a set of character strings (e.g. word or phrases) used in the body of text which are also found in a phrase synonym database; (c) selecting strings from first set, wherein a string from the set which is selected at a specific time can be labeled the target string; (d) for each target string: identifying a synonym string (e.g. word or phrase) which is a synonym for the target string (e.g. has a similar meaning as the target string) from the database, identifying a plurality of other strings which are not synonyms for the target string (or at least are not selected as synonyms); presenting the person with the target string; presenting the person with the synonym string and the plurality of other strings (e.g. in randomized order); and asking the person to select the synonym string.

In an example, a multiple-choice question can present a person with a target string (e.g. word or phrase) selected from a body of text and a plurality of other strings, and then give the person a multiple-choice question asking them to identify the other string with the most similar meaning to that of the target string, wherein the other string with the most similar meaning is obtained from a phrase synonym database.

In an example, a phrase synonym database can have records for over 20,000 strings (e.g. words or phrases), wherein each record comprises multiple fields selected from the following group: target string (e.g. word or phrase); rarity score (e.g. measure of how infrequently found in a large corpus of text) for the target string one or more synonym strings for the target string; and rarity scores for the target string for the one or more synonym strings. In an example, a phrase synonym database can be created by a machine (e.g. artificial intelligence) and then used identifying target (e.g. key) strings in a body of text and synonyms for those strings.

In an example, a method for testing a person's understanding of a body of text can comprise:
(a) receiving a body of text from a person; (b) prompting a machine process (e.g. artificial intelligence) to identify a first set of key character strings in the body of text; (c) prompting a machine process (e.g. artificial intelligence) to create a second set of character strings, wherein for each string in the first set there is a corresponding string in the second set with the same meaning as the string in the first set; (d) create a quiz or test which, for each string in the first set: presents the person with a string from the first set; presents the person with a list of alternative strings, wherein the list of alternative strings includes the corresponding string in the second set with the same meaning as the string in the first set; and asks the person to select the corresponding string from the second set.

In an example, a method can include using artificial intelligence or other machine assistance to identify a string with a meaning close to the meaning of the target string in a body of text submitted by a student for an assignment. In an example, a multiple-choice question can present a person with a target string (e.g. word or phrase) selected from a body of text and a plurality of other strings, and then give the person a multiple-choice question asking them to identify the other string with the most similar meaning to that of the target string, wherein the other strings are identified by a machine (e.g. artificial intelligence). As used herein, the term “synonyms” can mean single words with similar (e.g. substantially equivalent) meanings and also multi-word phrases with similar (e.g. substantially-equivalent) meanings.

In an example, a method for testing a person's understanding of a body of text can comprise: extracting a target statement from a body of text (e.g. an assignment) which has been submitted by a person (e.g. a student); presenting the person with the target statement and a plurality of other statements, wherein only one of the other statements supports (e.g. provides evidence for) the target statement; and asking the person to select the other statement which supports (e.g. provides evidence for) the target statement. As another embodiment, a method can include using artificial intelligence or other machine assistance to create a question: (a) presenting a student with a target string used in a body of text submitted by a student for an assignment; and (b) asking the student to select a string from among a plurality of alternative strings which is consistent with, agrees with, and/or supports the target string.

In an example, a method for testing a person's understanding of a body of text can comprise:
(a) receiving a body of text (e.g. an assignment) submitted by a person (e.g. a student); (b) identifying a target statement in the body of text; (c) prompting a machine (e.g. artificial intelligence) to generate an opposing statement which disagrees with (e.g. which opposes, undermines, or contradicts) the target statement; (d) prompting a machine (e.g. artificial intelligence) to generate a plurality of supportive statements which agree with (e.g. which support, affirm, or paraphrase) the target statement; (e) creating a question which presents the person with the target statement, wherein the question also presents the person with the opposing statement and the plurality of supporting statements (e.g. in a randomized order); and (f) asking the person to identify the opposing statement.

In an example, a method for testing a person's understanding of a body of text can comprise:
(a) receiving a body of text (e.g. an assignment) submitted by a person (e.g. student); (b) prompting a machine (e.g. artificial intelligence) to identify a first set of statements (e.g. facts or assertions) written in the body of text; (c) prompting a machine (e.g. artificial intelligence) to create a second set of statements wherein each statement in the second set corresponds to and contradicts and/or disagrees with a statement in the first set; and (d) creating a quiz which asks the person a question for each statement in the first set, wherein the statement in the first set for a given question is called the target statement, and wherein each question presents the person with the target statement, the statement from the second set corresponding to the target statement, and a plurality of other statements from the second set; and (e) asking the person to select the statement from the second set corresponding to (e.g. contradicting) the target statement.

In an example, a phrase synonym database may include only strings which are sufficiently complete that their meanings are unambiguous without additional context (e.g. without knowing what words are before and after a string in a particular instance). As another embodiment, the creation of a phrase synonym database can include consideration of the context in which a target string (e.g. word or phrase) is used. For example, the word “spot” could be a noun in one context and a verb in another context. In another example, the word “spot” by itself would be ambiguous and not included as a target string in a phrase synonym database. However, the strings “a spot” and “to spot” are not ambiguous and can be included in a phrase synonym database. In an example, if a machine process (e.g. artificial intelligence) is used to identify a synonym for a target string in a body of text, then the prompt for this machine process can ask the process to consider the context (e.g. surrounding words) for the target string.

In an example, a phrase synonym database can include one or more of the following fields for each string (e.g. word or phrase) in the database: commonality (e.g. how commonly the string is found in a large corpus of text); rarity score (e.g. how rarely the string is found in a large corpus of text); vocabulary level the highest-vocabulary-level word in the string; average vocabulary level or words in the string; character length of the string; character length of the longest word in the string; and average character length of words in the string.

A method for testing a student's understanding of the content of a body of text submitted by the student for an assignment comprising: (a) creating a plurality of field-specific phrase synonym databases; wherein a field is a field of study, discipline, field of research, type of profession, and/or news topic; wherein a field-specific phrase synonym database has a record for each character string (e.g. word or phrase) and at least one synonym for the string, and wherein each record also includes a rarity score (and/or vocabulary level) for the character string; (b) receiving a body of text submitted by a student for an assignment; (c) using a machine (e.g. artificial intelligence) to identify the field of the body of text; (d) scanning the body of text to identify strings (e.g. words or phrases) which are found in the field-specific phrase synonym database specific to the identified field; (e) selecting target strings (e.g. words or phrases) from among the identified strings, wherein target strings have higher rarity scores and/or vocabulary levels from the field-specific phrase synonym database (e.g. in the highest x% of scores or levels among identified strings); and (f) creating a quiz which measures the student's understanding of the target strings (e.g. such as by asking the student to match each target string with a synonym for that target string).

In an example, a field can be a particular academic discipline (e.g. biology), professional field (e.g. accounting), topic type (e.g. horses), or prose modality (e.g. poetry). In an example, a field-specific rarity score assigned to a string (e.g. word or phrase) can be an inverse (or negative) function of the number (or percentage) of people in a specific field who are able to correctly define the string (and/or identify synonyms or antonyms for the string).

In an example, a method for extracting information from a body of text (e.g. an assignment) submitted by a person (e.g. a student) can include sequentially scanning characters in the body of text and converting lower case letters to upper case letters before scanning the body of text to select key statements, strings, word, or phrases. In an example, a method for extracting information from a body of text (e.g. an assignment) submitted by a person (e.g. a student) can include sequentially scanning characters in the body of text and converting strings of two or more spaces into a single space before scanning the body of text to select key statements, strings, word, or phrases. In an example, a method for testing a person's (e.g. student's) understanding of a body of text (e.g. submitted assignment) can comprise sequentially-scanning through successive character positions in the body of text to identify target strings (e.g. target strings), and then asking the person (e.g. student) questions about the target strings.

In an example, a method for testing a person's understanding of a body of text can comprise scanning sequential character positions in a submitted body of text and then, for each character position, scanning a selected number or range of subsequent characters (e.g. 4 to 100) to identify target strings (e.g. words or phrases) which are also in a (predetermined) database. In another example, a method can include one or more processing steps applied to a student's submission of a body of text for an assignment before selection of content for inclusion in a quiz. In an example, one or more processing steps can be selected from the group consisting of: changing punctuation characters (e.g. changing commas, periods, and quotes to spaces); changing spacing (e.g. changing tabs to spaces and a sequence of multiple spaces into a single space); changing character cases (e.g. lower case to upper case, or vice versa); and changing numerical characters (e.g. changing digits to spaces).

In an example, a method for administering an online quiz to measure a student's understanding of the content in a body of text can include one or more steps to reduce potential use of machine assistance (e.g. AI assistance) in taking the quiz, wherein these one or more steps can be selected from the group consisting of: camera monitoring (e.g. of line of sight or hand motion) to detect potential machine assistance; presenting quiz questions via one or more modalities to confound potential machine assistance; presenting quiz questions with fonts or patterns which confound potential machine assistance; providing sufficient time to answer questions from the student's own knowledge, but not sufficient time to enlist machine assistance; and tracking the configuration(s) of one or more open windows on a computing device to detect potential machine assistance.

In an example, a method for testing a person's understanding of a body of text can comprise:
(a) receiving a body of text (e.g. a written assignment) submitted by a person (e.g. student); (b) prompting a machine (e.g. artificial intelligence) to create a quiz comprising a plurality of multiple-choice questions with correct answers based on content in the body of text, wherein the quiz is administered online, and wherein the same amount of time is given for each question to select the correct answer. In an example, the time given for a person to answer a multiple-choice question on a quiz can be a positively-correlated with the number of alternative choices for the question.

In an example, a quiz to measure a student's understanding of a body of text can be administered via one or more of modalities or devices selected from the group consisting of: augmented reality eyewear, computer mouse or other pointing device, electronic tablet, gesture recognition, headphones, laptop computer, paper, phone, smart watch, speech recognition software, television, and touch screen.

In an example, a method for testing a person's understanding of a body of text can comprise:
(a) receiving a body of text (e.g. a written assignment) submitted by a person (e.g. student); (b) prompting a machine (e.g. artificial intelligence) to create a quiz comprising a plurality of multiple-choice questions with correct answers based on content in the body of text; (c) asking the person to select the correct answer for each question in the quiz. In an example, generative AI can be used to generate a multiple-choice quiz based on a body of text submitted by a student for an assignment and administer the quiz to the student online, wherein questions in the quiz present the student with selected statements made in the body of text and ask the student to select other statements which are consistent (or, alternatively, inconsistent) with the selected statements.

In an example, integrating an AI-generated quiz into an existing learning management system can greatly improve the practical functionality of the system. For example, it can encourage students to really understand the content of what they are submitting, even if they use AI to help write an assignment. Also, it can help instructors to focus on evaluating student learning rather than having to worry about being a detective (e.g. trying to figure out whether the assignment has been largely written by AI).

In an example, a method can be implemented using a machine process (e.g. artificial intelligence). There are several reasons why the herein-disclosed method for using AI to create a quiz to test a student's understanding of a body of text which they submit for an assignment provides practice and technical advantages over the current practice of using AI to detect AI-written content in a body of text. For example, AI is constantly evolving. This makes the current practice of using AI to try to detect AI-written content a moving target at best and a wild goose chase at worst. The novel application of AI to create a quiz to test student understanding of material in their submitted assignment which is disclosed herein avoids this problem and restores the focus on education and learning.

In an example, a method for testing a student's understanding of content in a body of text which the student submitted for an assignment can comprise using a machine process (e.g. artificial intelligence) to perform one or more of the following steps: evaluating the rarity or vocabulary level of target strings (e.g. words or phrases); identifying string synonyms for (e.g. words or phrases with the same meaning as) target strings; identifying the most important words, phrase, and/or statements in the body of text; identifying the primary field of a body of text (e.g. for selection of a field-specific database); identifying the words, phrases, and/or statements in the body of text which are most relevant to the assignment topic or instructions; scanning the body of text to identify target strings (e.g. words or phrases); selecting a subset of target strings for inclusion in a quiz to test the student's understanding; and selecting word or phrases in the body of text which are most unusual, most rare, or having the highest vocabulary levels.

In an example, a method for testing a student's understanding of a body of text submitted by the student for an assignment can include modifying (e.g. in real time) the content, format, and/or difficulty-level of subsequent questions in a quiz based on the student's answers to previous questions. In another example, a method for testing a student's understanding of a body of text submitted by the student for an assignment can include using a machine process (e.g. artificial intelligence) to modify (e.g. in real time) the content, format, and/or difficulty-level of subsequent questions in a quiz based on the student's answers to previous questions. In an example, a method to test a student's knowledge of a body of text submitted for an assignment can take the form of: a multiple-choice quiz generated based on the content of the body of text; or an interactive dialog based on the content of the body of text. In an example, one or more synonyms for a target string can be generated in real time by machine (e.g. artificial intelligence) to help create a multiple-choice question.

In an example, a body of text submitted by a student for an assignment can be entered through an application programming interface. In an example, a method can be implemented on a server over a network such as the Internet or World Wide Web. In an example, a method can be executed in a hardware component such as a data processor. In an example, a method can be implemented on a database server. In another example, a method can be implemented using a personal computer. In an example, a method can be implemented via the internet. In another example, a method for measuring a student's understanding of the content of a body of text which the student submits for an assignment can be performed by a data processor which stores and executes program code.

In an example, a machine-learning (e.g. artificial intelligence) based method for testing a student's understanding of the content of a body of text which the student submits for an assignment can be embodied in a non-transitory computer readable medium. In an example, a method can be embodied in a computer program written in a language selected from the group consisting of: Javascript, Kotlin, MonTEE, Python, PHP, Ruby, Java, Swift, C #, and Go. In an example, a method can be implemented in a computer-readable storage medium. In an example, a method can be implemented via a computer program, software, software application, script, or code. In an example, a method can include a computer program. As another embodiment, any of the steps, operations, or processes of a method can be executed by a computer program code. In another example, a (character) string can be a single word, a multi-word phrase, or a multi-word statement.

In an example, a body of text submitted by a student for an assignment can comprise one of the following types of text: biographic profile, blog entry, book report, business analysis, case study analysis, composition, discussion post, dissertation, editorial, editorial piece, email, essay, financial analysis, financial valuation, grant proposal, journal article, journal article review, lab report, legal brief, letter, literature review, magazine article, marketing plan, master's thesis, medical notes, movie review, news article, novel, patent application, performance review, pitch deck, play, poem, public speech, real property description, report, research paper, resume or CV, screen play, short story, slide show, song lyrics, strategic plan, SWOT analysis, and valuation analysis.

In an example, a method for measuring a student's understanding of a body of text submitted by the student for an assignment can include using (e.g. prompting) a machine process (e.g. artificial intelligence) to create quiz, wherein the machine process (e.g. artificial intelligence) is asked (e.g. prompted) to consider whether the body of text is one of the following types of text: biographic profile, blog entry, book report, business analysis, case study analysis, composition, discussion post, dissertation, editorial, editorial piece, email, essay, financial analysis, financial valuation, grant proposal, journal article, journal article review, lab report, legal brief, letter, literature review, magazine article, marketing plan, master's thesis, medical notes, movie review, news article, novel, patent application, performance review, pitch deck, play, poem, public speech, real property description, report, research paper, resume or CV, screen play, short story, slide show, song lyrics, strategic plan, SWOT analysis, and valuation analysis.

Although AI detectors in the prior art have some value, those which produce a statistic (e.g. an estimated probability or percentage of AI content in a body of text) can be problematic for course instructors (e.g. faculty). For example, at what statistic level should an instructor take action and what action should they take? If an instructor erroneously confronts a student based on an (arbitrarily-high) AI detector statistic and turn turns out that the student did not use AI, then this harms the student-instructor relationship. The instructor may even be liable for a complaint of bias. On the other hand, if an instructor fails to take action based on an AI detector statistic, then this can encourage unthoughtful use of AI, erosion of student learning, and a break-down of education. The methods disclosed herein are a technological advancement over such AI detectors. These methods place the focus on learning (not detective work) and do not put instructors in a non-win predicament.

Integration of AI into a learning management system to create a quiz based on material in an assignment submitted by a student in order tests the student's understanding of core statements and concepts expressed in the assignment in ways which are not possible with current AI detection services. Universities and other schools are currently facing a tremendous challenge concerning the use of AI by students for assignments. Taking a hardline and forbidding the use of AI for assignments is not satisfactory because thoughtful use of AI is an important tool for students to learn. Also, it is hard to enforce because AI is continually evolving and AI detectors have a hard time keeping up. On the other hand, allowing students to use AI to completely write assignments can reduce learning and undermine education. The novel integration of AI into learning management systems disclosed herein can provide a practical and technically-elegant solution to this challenge. It holds a student responsible for understanding the content of what they submit for an assignment, regardless of the degree to which they do, or do not, use AI to help them write it.

In an example, a method can be a computer-implemented pipeline that extracts content from a body of text submitted by a student to a school's Learning Management System (e.g. via LTI) and produces a reviewable assessment item (e.g. such as a quiz) that is strictly-grounded in that submitted body of text. For example, this method can comprise: (a) normalizing and segmenting the body of text; (b) scoring strings (e.g. words, phrases, or sentences) for salience; and (c) building a structured instruction for a Large Language Model (LLM) that operates in a closed-book manner on the supplied text only. In this embodiment, a student's submission is the sole source of truth for the generated quiz.

In an example, a model can: draft candidate questions (e.g. which ask a student to perform synonym identification, factual recall, and/or theme expression) in a defined JSON schema; and use deterministic validators to enforce schema conformance, deduplicate, and run a context-consistency check requiring each question and keyed answer to be directly supported by the student's submitted body of text. In an embodiment, items which are not supported (e.g. justified) by the submitted body of text can be rejected or regenerated. In an example, each run can record an audit trail (input reference, prompt/version, model identifier/parameters, validator outcomes) for reproducibility and human review. In an example, only approved items and scores are returned to the LTI application. The inventive and technological contributions of this method include controlled architecture and pre-analysis, leading to closed-book LLM drafting, in turn leading to strict text-grounded validation with human-in-the-loop. This sequence reliably converts long-form student work into traceable and reviewable assessments.

As a general principle, a student should be responsible for understanding the content of what they submit as a written assignment, even if they use a tool such as machine (e.g. artificial intelligence) to help them write it. A method for testing the student's understanding of what they submit can help maintain a focus on learning, not a cat-and-mouse game of machine (e.g. artificial intelligence) use and machine (e.g. artificial intelligence) use detection between a student and an instructor.

In an example, a method for measuring a student's knowledge and/or understanding of a body of text submitted for an assignment can comprise: receiving a first body of text submitted for an assignment by a student; selecting target strings from among strings found in the first body of text, wherein a string is a string of characters comprising a word, a phrase, or a statement; and creating questions for the student based on the target strings, wherein the questions comprise an assessment tool (e.g. quiz) to measure the student's knowledge of content in the first body of text.

In an example, a method for testing a person's understanding of a body of text can comprise:
(a) receiving a first body of text (e.g. an assignment) on a selected topic which has been submitted by a person (e.g. student); (b) prompting a machine (e.g. artificial intelligence) to compose a second body of text on the same topic; (c) selecting a first sentence from the first text, wherein the first sentence is selected based on one or more of the following attributes: average length of words in the statement; average vocabulary level of words in the statement; concluding sentence of the body of text; first sentence of a paragraph; highest-vocabulary word in the statement; and importance to the body of text as evaluated by a machine (e.g. artificial intelligence); longest word in the statement; sentence containing the most words in common with the instructions for an assignment; sentence containing the most words in common with the title of the body of text; and statement for which a citation (e.g. reference or source) is noted; (d) selecting a plurality of second sentences from the second text, wherein the second sentences are selected based on one or more of the following attributes: average length of words in the statement; average vocabulary level of words in the statement; concluding sentence of the body of text; first sentence of a paragraph; highest-vocabulary word in the statement; and importance to the body of text as evaluated by a machine (e.g. artificial intelligence); longest word in the statement; sentence containing the most words in common with the instructions for an assignment; sentence containing the most words in common with the title of the body of text; and statement for which a citation (e.g. reference or source) is noted; ; (e) creating a question which presents the person with the first sentence and the plurality of second sentences (e.g. in randomized order); and (f) asking the person to identify the first sentence.

In an example, a method, process, or system for measuring a student's understanding of a body of text submitted by the student for an assignment can be integrated with (e.g. function as a module within) a school's learning management system.

In an example, a method for testing a person's understanding of a submitted body of text can comprise creating and administering a quiz with 5 to 20 multiple choice questions based on 5 to 20 target strings (e.g. words or phrases) selected from the submitted body of text. In an example, a method for testing a person's understanding of a submitted body of text can comprise creating and administering a quiz with multiple choice questions based on the content of the submitted body of text. In an example, a quiz can be structured with multiple-choice questions, wherein each question tests a student's understanding of the meaning of a word, phrase, or statement made in a body of text submitted by the student.

In an example, a character string (e.g. word or phrase) can be selected from a body of text based on string containing one or more words not found in a dictionary. In an example, a method can include ranking strings (e.g. words or phrases) from a body of text in decreasing order of rarity scores and selecting target strings in this descending order (starting at the top and working down in rarity scores) until a pre-determined number (e.g. between 5 and 50) of target strings has been selected for inclusion in a quiz. In another example, a rarity score assigned to a string (e.g. word or phrase) can be an inverse (or negative) function of the number (or percentage) of people who are able to correctly identify synonyms and/or antonyms of the string (e.g. based on cumulative previous quiz results). As another embodiment, rarity scores for strings (e.g. words or phrases) can be an inverse (or negative) function of the number and/or percentage of people whose test results indicate understanding of their meanings. In an example, target strings (e.g. words or phrases) which are the most rare (e.g. least commonly used and highest rarity scores) can be selected.

In an example, a phrase synonym database can be continuously updated (e.g. including Bayesian updates of rarity scores for strings) based on new bodies of text which are submitted for review. In an example, a sentence can be selected from a body of text based on average rarity score of strings (e.g. higher score for strings used less often in a large corpus of text) in the sentence which are also found in a phrase database. In another example, rarity scores for strings (e.g. words or phrases) in a phrase synonym database can be increased when newly-submitted bodies of text include those strings frequently. In an example, rarity scores for strings (e.g. words or phrases) in a phrase synonym database can be updated using Bayesian statistics based on a cumulative corpus of text which grows with as new bodies of text are submitted. In another example, a large corpus of text (which is used to calculate rarity scores for strings) can include the cumulative content of all previously-submitted bodies of text analyzed by a method. In an example, a rarity score for a string (e.g. word or phrase) can be higher for a string which is found less often in a large corpus of text and lower for a string which is found more often in the large corpus of text.

In an example, a character string (e.g. word or phrase) can be selected from a body of text based on rarity of word(s) in the string as evaluated by AI. As another embodiment, a method for measuring a student's understanding of the content of a body of text which the student submitted for an assignment can comprise: receiving a body of text from the student; automatically scanning the body of text to identify character strings (e.g. words or phrases); using a machine process (e.g. artificial intelligence) to automatically identifying the field (e.g. field of study, discipline, field of research, type of profession, and/or news topic) addressed by the body of text; automatically assigning field-specific rarity scores and/or vocabulary levels to strings identified in the body of text; automatically selecting target strings with high rarity scores and/or vocabulary levels from the strings identified in the body of text; and automatically creating a quiz which measures the student's understanding of these target strings. In an example, a sentence can be selected from a body of text based on sentence selected by AI in response to prompt asking for selection of most unusual (e.g. least commonly found) sentence(s) in the body of text.

In an example, a character string (e.g. word or phrase) can be selected from a body of text based on vocabulary level of the highest-vocabulary-level word in the string. In an example, a sentence can be selected from a body of text based on average vocabulary level of words in the sentence. In another example, target strings (e.g. words or phrases) with the highest vocabulary levels can be selected. In an example, a method can include using artificial intelligence or other machine assistance to evaluate the vocabulary levels of strings to help select target strings from a body of text submitted by a student for an assignment. In another example, a sentence can be selected from a body of text based on average vocabulary level of strings (e.g. words or phrases) in the sentence which are also found in a phrase database. In an example, a character string (e.g. word or phrase) can be selected from a body of text based on length of the string. In an example, a sentence can be selected from a body of text based on length of the longest string (e.g. word or phrase) in the sentence which is also found in a phrase database. In an example, when selecting a synonym for a target string (e.g. word or phrase) among a plurality of alternative synonym strings, if the vocabulary levels of the plurality of strings are not known, then (maximum) word length can be used as a proxy for vocabulary level and the synonym with the shortest (maximum) word length can be selected.

In an example, a method for testing a person's understanding of a body of text can comprise:
(a) receiving a body of text (e.g. an assignment) submitted by a person (e.g. a student); (b) sequentially scanning the body of text (e.g. character-by-character) to identify space characters; (c) when a space character is found, scanning forward a selected number (or range) of characters (or spaces) to identify character strings (e.g. words or phrases) which are in a phrase synonym database, and then returning to the space character before progressing to the next sequential space character;
(d) compiling a set of strings identified as being in the body of text and in the database via the above steps; (e) sequentially selecting strings from the set, wherein a string from the set which is selected at a specific time can be labeled the target string, and wherein this selection is based on one or more of the following string attributes: least commonly used in a large corpus of text, highest rarity score, highest vocabulary level, or most important as evaluated by a machine (e.g. artificial intelligence);
(f) for each target string: identifying a synonym string (e.g. word or phrase) from the database which is a synonym for the target string (e.g. has a similar meaning as the target string), identifying a plurality of other strings which are not synonyms for the target string (or at least are not selected as synonyms); presenting the person with the target string; presenting the person with the synonym string and the plurality of other strings (e.g. in randomized order); and asking the person to select the synonym string. In an example, a prompt to a machine (e.g. artificial intelligence) to identify a synonym for a target string can include instructions for the machine (e.g. artificial intelligence) to consider the context (e.g. surrounding words) in which the target string is used in a body of text.

In an example, a method for testing a person's understanding of a submitted body of text can comprise creating and administering a quiz with 5 to 20 multiple choice questions based on 5 to 20 target strings (e.g. words or phrases) selected from the submitted body of text, wherein the target strings are selected based on their being found in a phrase synonym database. In an example, a sentence can be selected from a body of text based on number of strings (e.g. words or phrases) in the sentence which are also found in a phrase database. In another example, a target string (e.g. word or phrase) can be selected based on its being in a phrase synonym database.

In an example, a method can include selecting target strings from a body of text submitted by a student for an assignment at least partly based on the relevance, importance, and/or significance of the strings to the assignment, wherein strings with greater relevance, importance, and/or significance are more likely to be selected as target strings. In an example, a method for measuring a student's understanding of a body of text which the student submitted for an assignment can comprise testing the student's ability to select and list the most important statements, issues, or points made in the body of text. In an example, a sentence can be selected from a body of text based on number of strings (e.g. words or phrases) in common with the title of the body of text which are also in a phrase database.

In an example, a character string (e.g. word or phrase) can be selected from a body of text based on level of relevance of the string to the topic of the body of text (e.g. assignment description) as evaluated by AI. In another example, a character string (e.g. word or phrase) can be selected from a body of text based on string selected by AI in response to a prompt asking for selection of string(s) in the body of text which are most relevant to the topic (e.g. assignment description). In an example, a method for measuring a student's understanding of a body of text submitted by the student for an assignment can comprise using a machine process (e.g. artificial intelligence) to select target words, phrases, or statements from the body of text which are particularly relevant to the assignment instructions.

In an example, a method for testing a person's understanding of a body of text can comprise:
(a) receiving a body of text (e.g. an assignment) on a given topic from a person (e.g. a student); (b) prompting a machine (e.g. artificial intelligence) to select a plurality of target statements (e.g. sentences) made in the body of text, wherein this selection is based on the most important and/or relevant statements as evaluated by the machine; (c) prompting the machine to identify, for each target statement, a plurality of other statements on the same topic which were not made in the body of text; (d) creating a quiz which presents the person, for each target statement, the target statement and a plurality of other statements, and asking the person to select the target statement. In an example, a sentence can be selected from a body of text based on sentence selected by AI in response to prompt asking for selection of important sentence(s) in the body of text.

In an example, a statement can be selected from a body of text by a machine (e.g. artificial intelligence). In an example, a sentence can be selected from a body of text based on first sentence in a paragraph. As another embodiment, a sentence can be selected from a body of text based on sentence whose content is noted by a citation (e.g. as coming from a reference or source). In an example, a sentence can be selected from a body of text based on sentence selected by AI in response to prompt asking for selection of most controversial sentence(s) in the body of text.

In an example, a (target) sentence can be selected from a body of text (e.g. for use in a question to test understanding) based on one or more sentence attributes selected from the group consisting of the following: average length of strings (e.g. words or phrases) in the sentence which are also found in a phrase database; average length of words) in the sentence; average rarity score of strings (e.g. higher score for strings used less often in a large corpus of text) in the sentence which are also found in a phrase database; average rarity score of words in the sentence (e.g. higher score for strings used less often in a large corpus of text); average vocabulary level of strings (e.g. words or phrases) in the sentence which are also found in a phrase database; average vocabulary level of words in the sentence; closing sentence of the body of text; first sentence in a paragraph; infrequency of strings (e.g. words or phrases) in the sentence and in a phrase database, wherein frequency is frequency of use in a large corpus of text; infrequency of words in the sentence as previously found in a large corpus of text; length of the longest string (e.g. word or phrase) in the sentence which is also found in a phrase database; length of the longest word in the sentence; level of relevance of the sentence to the topic of the body of text (e.g. assignment description) as evaluated by AI; level of sentence importance as evaluated by AI; number of strings (e.g. words or phrases) in common with an assignment description and/or instructions which are also in a phrase database; number of strings (e.g. words or phrases) in common with the title of the body of text which are also in a phrase database; number of strings (e.g. words or phrases) in the sentence which are also found in a phrase database; number of words in common with an assignment description and/or instructions; number of words in common with the title of the body of text; number of words in the sentence which are also found in a phrase database; opening sentence of the body of text; rarity of strings (e.g. words or phrases) in the sentence as evaluated by AI which are also in a phrase database; rarity of words in the sentence as evaluated by AI; rarity score of the most infrequent (most rare and/or least commonly used) word in the sentence; rarity score of the most infrequent string (e.g. word or phrase) in the sentence which is also in a phrase database; sentence selected by AI in response to prompt asking for selection of important sentence(s) in the body of text; sentence selected by AI in response to prompt asking for selection of most unusual (e.g. least commonly found) sentence(s) in the body of text; sentence selected by AI in response to prompt asking for selection of most controversial sentence(s) in the body of text; sentence selected by AI in response to prompt asking for selection of sentence(s) in the body of text which are most relevant to the topic (e.g. assignment description); sentence whose content is noted by a citation (e.g. as coming from a reference or source); sentence whose person point of view (e.g. first person vs. third person) changes and/or differs from other parts of the body of text; string (word or phrase) in the sentence which is also found in a phrase database; vocabulary level of the highest-vocabulary-level string (e.g. word or phrase) in the sentence which is also in a phrase database; and vocabulary level of the highest-vocabulary-level word in the sentence.

In an example, a target statement can be selected from the body of text based on one or more of the following attributes: average rarity score of words in the statement; most rare word in the statement; average vocabulary level of words in the statement; highest vocabulary level word in the statement; and position of statement in a paragraph. In an example, target strings (e.g. words or phrases) can be selected from among all strings in a body of text based on one or more criteria selected from the group consisting of: rareness of their use in a large corpus of text; average length of words in them; length of longest word in them; average vocabulary level of words in them; and vocabulary level of highest vocabulary word in them. In another example, when one of a plurality of alternative synonyms for a target string (e.g. word or phrase) can be selected based on one or more attributes selected from the group consisting of: lowest rarity score; lowest vocabulary level; most commonly used; most similar meaning; not used elsewhere in the submitted body of text; and shortest length.

In an example, a method can include creating a question: (a) presenting a student with a plurality of strings; wherein a string is a string of characters comprising a word, a phrase, or a statement; and wherein one or more strings in the plurality are not in a body of text submitted by the student for an assignment and the other strings in the plurality are in the body of text; and (b) asking the student to select one or more strings which are not in the body of text. In another example, a method for testing a person's understanding of a body of text can comprise: (a) receiving a first body of text (e.g. an assignment) on a given topic submitted by a person (e.g. a student); (b) receiving or creating a second body of text on the topic which has not been submitted by the person; (c) selecting a first set of statements (e.g. sentences) from the first body of text; (d) selecting a statement (e.g. sentence) from the second body of text; (e) creating a question which presents the person with the first set of statements and the statement from the second body of text, in randomized order, and asks the person to select the statement from the second body of text.

In an example, a method can include using (e.g. prompting) AI to create a question: (a) presenting a student with a plurality of strings; wherein a string is a string of characters comprising a word, a phrase, or a statement; and wherein one string in the plurality is in a body of text (submitted by the student for an assignment) and the other strings in the plurality are not in the body of text; and (b) asking the student to select the string which is in the body of text. In an example, a method can include using (e.g. prompting) AI to: (a) present a student with a plurality of strings; wherein a string is a string of characters comprising a word, a phrase, or a statement; and wherein one string in the plurality is not in a body of text (submitted by the student for an assignment) and the other strings in the plurality are in the body of text; and (b) ask the student to select the string which is not in the body of text.

In an example, a person can be given a multiple-choice question wherein one answer is a statement made in a body of text which they submitted for an assignment and other answers are other statements which are not in the body of text, wherein the other statements are generated by a machine (e.g. artificial intelligence) prompted with the topic of the body of text (or related assignment description), and wherein the person is asked to select the statement made in the body of text.

In an example, a method can include creating a question: (a) presenting a student with a target string from a body of text with one or more words missing; wherein a string is a string of characters comprising a word, a phrase, or a statement; and (b) asking the student to select a string from among a plurality of alternative strings, wherein insertion of the string selected by the student for the one or more missing words restores the original meaning of the target string in the body of text.

In an example, a method for testing a person's understanding of a body of text can comprise:
(a) receiving a body of text (e.g. an essay or other assignment) from a person (e.g. a student); (b) selecting a key statement (e.g. a sentence) from the body of text, wherein the key statement is selected based on one or more criteria selected from the group consisting of: first sentence of a paragraph; concluding sentence of the body of text; sentence containing two or more words from the title of the body of text; sentence containing two or more words from the description of an assignment for which the body of text is submitted; statement for which a source (e.g. reference note) is cited; average length of words in the statement; longest word in the statement; average vocabulary level of words in the statement; highest-vocabulary word in the statement; and key statement in the body of text identified by a machine (e.g. artificial intelligence); (c) creating an incomplete version of the key statement by omitting (e.g. replacing with a blank) a first character string (e.g. between 5 and 100 characters in length) in the key statement, wherein the first character string is selected based on one or more criteria selected from the group consisting of: contains two or more words from the title of the body of text; contains two or more words from the description of an assignment for which the body of text is submitted; average length of words in the string; longest word in the string; average vocabulary level of words in the string; highest-vocabulary word in the string; and key string in the statement as identified by a machine (e.g. artificial intelligence); (d) presenting the person with the incomplete version of the statement and a plurality of alternative character strings from which one string can be selected to fill in the omitted part of the incomplete version, wherein one of the alternative character strings is the first character string, and wherein the rest of the alternative character strings are identified by machine (e.g. artificial intelligence); and (e) asking the person to select the first character string from among the alternative character strings.

In an example, a method for testing a person's understanding of a body of text can comprise:
(a) selecting a statement (e.g. a sentence) made in a body of text; (b) selecting a target string (e.g. word or phrase) within the selected statement; (c) presenting a person with the statement with the target string omitted (e.g. replaced by a blank line); (d) presenting the person with a plurality (e.g. list) of strings which includes a synonym for the target string and also other strings (e.g. in a randomized order); and (e) then asking the person to select the synonym which makes the statement have the same meaning as the original statement in the body of text.

In an example, a method for testing a person's understanding of a body of text can comprise:
(a) selecting a statement from a body of text (e.g. an assignment) submitted by a person (e.g. a student); (b) selecting a target character string (e.g. word or phrase) in the statement, wherein the target character string is selected based on one or more of the following attributes: contains highest-vocabulary-level word(s) in the statement; contains word(s) in common with the instructions for the assignment for which the body of text was submitted; contains word(s) in common with title of the body of text; and uncommon or rare (e.g. infrequently found in previous analysis of a large corpus of text); (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is the target character string; and (e) asking the person to select the character string in the plurality of character strings which, when inserted into the incomplete version, restores the incomplete version to the statement originally in the body of text. In an example, a quiz can include a multiple-choice question, wherein multiple alternative strings (e.g. words or phrases) are given to fill in a blank in a statement made in a submitted body of text, and wherein the student who submitted the body of text has to pick the best alternative string to match the meaning of the original statement.

In an example, a method for testing a person's understanding of a body of text can comprise:
(a) receiving a body of text from a person; (b) identifying key character strings in the body of text which are found in a synonym database; (c) selecting a statement (e.g. a sentence) from the body of text which includes one of the key character strings; (d) creating an incomplete version of the selected statement by omitting (e.g. replacing with a blank) the key character string in the selected statement; (e) presenting the person with the incomplete version of the statement and a plurality of second character strings from which one string can be selected to fill in the omitted part of the incomplete version, wherein one of the second character strings is a synonym for the key character string in the statement extracted from in the phrase synonym database; and (f) asking the person to select the second character string which changes the incomplete version into a statement with the same meaning as the selected statement in the body of text.

In an example, a method for testing a person's understanding of a body of text can comprise:
(a) selecting a statement from a body of text (e.g. an assignment) submitted by a person (e.g. a student); (b) selecting a target character string (e.g. word or phrase) in the statement; (c) creating an incomplete version of the statement by omitting (e.g. replacing with a blank) the target character string in the statement; (d) presenting the person with the incomplete version and a plurality of alternative character strings to fill in the missing part of the incomplete version, wherein one of the strings in the plurality is a synonym for (e.g. has virtually the same meaning as) the target character string, and wherein the synonym is identified using a phrase synonym database; and (e) asking the person to select the character string in the plurality of character strings which, when inserted into the incomplete version, creates a statement which has the same meaning as the statement originally in the body of text.

In an example, a method for testing a person's understanding of a body of text can comprise a multiple-choice fill-in-the blank question based on one or more statements made in the body of text, wherein the statements are selected by prompting a machine (e.g. artificial intelligence) to select the most important statements in the body of text. In another example, a method for testing a student's understanding of a body of text submitted for an assignment can comprise a multiple-choice fill-in-the blank question based on one or more statements made in the body of text, wherein the statements are selected by prompting a machine (e.g. artificial intelligence) to select the statements in the body of text which are most relevant to the instructions for the assignment.

In an example, a method for testing a person's understanding of a body of text can comprise:
(a) selecting statements (e.g. sentences) in a selected paragraph in a body of text in the order in which they appear; (b) presenting the statements to a person in a randomized order; and (c) asking the person to reorder the statements into the order in which they appeared in the paragraph. In another example, a method for testing a person's (e.g. student's) understanding of a body of text (e.g. submitted assignment) can comprise sequentially-scanning through successive character positions in the body of text to identify target strings (e.g. words or phrases); and then asking the person (student) questions about the target strings, wherein a question asks the person (student) to select a synonym or antonym for a target string from a list which includes alternative (non synonym or antonym) strings.

In an example, a method for testing a person's understanding of a body of text can comprise:
(a) receiving a body of text (e.g. an assignment) submitted by a person (e.g. a student); (b) using a machine to scan the body of text character-by-character to identify a set of character strings (e.g. word or phrases) used in the body of text; (c) sequentially selecting strings from the set, wherein a string from the set which is selected at a specific time can be labeled the target string; (d) for each target string: identifying a synonym string (e.g. word or phrase) which is a synonym for the target string (e.g. has a similar meaning as the target string), identifying a plurality of other strings which are not synonyms for the target string (or at least are not selected as synonyms); presenting the person with the target string; presenting the person with the synonym string and the plurality of other strings (e.g. in randomized order); and asking the person to select the synonym string.

In an example, a person can be given a question which asks the person to select the string (e.g. word or phrase) among a plurality of alternative strings whose meaning is closest to that of a target string, wherein the target string is found in a body of text submitted by the person. In an example, generative AI can be used to generate a multiple-choice quiz based on a body of text submitted by a student for an assignment and administer the quiz to the student online, wherein questions in the quiz present the student with selected words and/phrases used in the body of text and ask the student to select other words or phrases with the most similar meanings to the selected words or phrases, and wherein words or phrases which are particularly relevant to the topic (or instructions) of the assignment are selected.

In an example, a method for testing a person's understanding of a body of text can comprise:
(a) receiving a body of text (e.g. an assignment) submitted by a person (e.g. student); (b) identifying a target character string in the body of text which is also in a phrase synonym database; (c) extracting a set of a synonyms for the target character string from the phrase synonym database; (d) removing any synonyms from the set which are also in the body of text; (e) creating a question which presents the person with the target character string and remaining synonyms in the set (e.g. in a randomized order); and (f) asking the person to select the target character string. In an example, a phrase synonym database can be used to identify strings with similar meanings (e.g. phrase synonyms) to a target string found in a body of text and also to help identify strings which do not have similar meanings to the target string, wherein both types of strings can be used in a multiple choice question concerning the target string.

In an example, a phrase synonym database can have variable length records, wherein each record has a field for a target string (e.g. word or phrase) and one or more fields for synonyms for the target string (e.g. strings with the same or similar meaning to the target string. In an example, a phrase synonym database can be created: by human work identifying strings (e.g. words and phrases) and their synonyms; by machine (e.g. artificial intelligence) identifying strings and their synonyms; or by a combination of machine and human work.

In an example, a method for testing a person's (e.g. student's) understanding of a body of text (e.g. submitted assignment) can comprise using artificial intelligence to sequentially-scan through successive character positions in the body of text to identify target strings (e.g. words or phrases) and ask the person (student) questions about the target strings, wherein a question asks the person (student) to select a synonym or antonym for a target string from a list which includes alternative (non synonym or antonym) strings. As another embodiment, a method for testing a person's understanding of a body of text can use a machine (e.g. artificial intelligence) to identify synonym strings for target strings found in the body of text. In an example, a plurality of strings (e.g. words or phrases) which are not synonyms for a target string can be identified by a machine (e.g. artificial intelligence) and used as incorrect answers in a multiple-choice question concerning the target string.

Traditionally, the term “synonym” has been applied to a single word whose meaning is similar to that of another single word. In this disclosure, the term “synonym” (or “phrase synonym”) is more-generally applied to include multiword phrases. For example, when a second character string (e.g. word or multiword phrase) has the same meaning as a first character string (e.g. word or multiword phrase), then second string can be called a “synonym” (“phrase synonym”) of the first string.

In an example, a method for testing a person's understanding of a body of text can comprise: extracting a target statement from a body of text (e.g. an assignment) which has been submitted by a person (e.g. a student); presenting the person with the target statement and a plurality of other statements, wherein only one of the other statements disagrees with (e.g. is inconsistent with) the target statement; and asking the person to select the other statement which disagrees with (e.g. is inconsistent with) the target statement. In an example, a method can include using artificial intelligence or other machine assistance to create a question: (a) presenting a student with a target string used in a body of text submitted by a student for an assignment; and (b) asking the student to select a string from among a plurality of alternative strings which is inconsistent with, disagrees with, and/or does not support the target string.

In an example, a method for testing a person's understanding of a body of text can comprise:
(a) receiving a body of text (e.g. an assignment) submitted by a person (e.g. a student); (b) identifying a target statement in the body of text; (c) prompting a machine (e.g. artificial intelligence) to generate a supportive statement which is in agreement with (e.g. which supports, affirms, or paraphrases) the target statement; (d) prompting a machine (e.g. artificial intelligence) to generate a plurality of opposing statements which disagree with (e.g. which oppose, undermine, or contradict) the target statement; (e) creating a question which presents the person with the target statement, wherein the question also presents the person with the supportive statement and the plurality of opposing statement (e.g. in a randomized order); and (f) asking the person to identify the supportive statement.

In an example, a phrase synonym database can include pre-defined target strings (e.g. words or phrases) and, for each target string, one or more corresponding strings with similar meanings to the target string. In an example, in addition to phrase synonyms, a database can also include antonyms for strings (e.g. words or phrases). In another example, a large corpus of text can comprise the cumulative content of publicly-available text material. In an example, a phrase synonym database can include rarity scores, vocabulary level scores, and character lengths in addition to phrase synonyms.

In an example, a database of strings (e.g. words or phrases) which is used in a method to test a student's understanding of content in a body of text can be a field-specific, wherein a field can be selected from the following group: Business, Investment, Real Estate, Fashion, Military, Engineering, Mathematics, Utilities, Chemistry, Restaurants, Anthropology, Health Care, Clothing, Journalism, Retail, Commodities, Law, Shipping, Communications, Legislation, Sociology, Banking, Insurance, computer Science, Library Science, Textiles, Construction, Linguistics, Theater, Economics, Literature, Tourism, Fine Art, Music, Finance, Mining, Biology, International Trade, Public Administration, Biomedical, Internet, Paulslevenics, Public Utilities, Aerospace, Food Industry, Natural Sciences, Timjamesology, Architecture, History, Philosophy, Religion, Art, Hospitality, Physics, Astronomy, Information Technology, Psychology, Entertainment, Medicine, Agriculture, Geography, Nursing, Energy, Marketing, Transportation, Artificial Intelligence, Humanities, Politics, Education, Manufacturing, and Trade.

In an example, a field-specific database can specific to a particular academic discipline (e.g. biology), professional field (e.g. accounting), topic type (e.g. horses), or prose modality (e.g. poetry), wherein a field-specific database can be selected for a specific body of text based on the field of the body of text. In an example, a phrase synonym database can be a field-specific database, focused on the literature in a particular field (e.g. medicine or engineering), on a particular topic (e.g. flowers or bicycles), or of a particular mode of text (e.g. prose, poetry, other).

In an example, a method for extracting information from a body of text (e.g. an assignment) submitted by a person (e.g. a student) can include sequentially scanning characters in the body of text and converting question mark characters or exclamation point characters into period characters before scanning the body of text to select key statements, strings, word, or phrases. In another example, a method for extracting information from a body of text (e.g. an assignment) submitted by a person (e.g. a student) can include sequentially scanning characters in the body of text and converting upper case letters to lower case letters before scanning the body of text to select key statements, strings, word, or phrases.

In an example, a method for testing a person's understanding of a body of text can comprise:
(a) receiving a body of text (e.g. an assignment) submitted by a person (e.g. a student); (b) scanning the body of text character-by-character to identify a set of key character strings (e.g. word or phrases) used in the body of text, wherein for each sequential character the method scans forward 4 to 100 characters to search for strings and then returns to the sequential character before progressing to the next sequential character; (c) selecting strings from the set, wherein a string from the set which is selected at a specific time can be labeled the target string; (d) for each target string: identifying a synonym string (e.g. word or phrase) which is a synonym for the target string (e.g. has a similar meaning as the target string), identifying a plurality of other strings which are not synonyms for the target string (or at least are not selected as synonyms); presenting the person with the target string; presenting the person with the synonym string and the plurality of other strings (e.g. in randomized order); and asking the person to select the synonym string.

In an example, a body of text can be processed and/or filtered before it is scanned for identification of words or phrases. In an example, a method for testing a person's understanding of a body of text can comprise a character-processing step before the body of text is scanning for one or more target sentences or target strings (e.g. words or phrases). As another embodiment, character—processing steps can include one or more of the following: changing a numerical digit (e.g. changing a digit to a space); changing a punctuation character (e.g. changing an exclamation mark to a period); changing a tab (e.g. to a space); changing quote marks (e.g. changing a quote mark to a space); changing sequential spaces (e.g. changing two spaces to one space); and changing the case of characters (e.g. upper vs. lower case).

In an example, a method for testing a person's understanding of a body of text can comprise:
(a) receiving a body of text (e.g. a written assignment) submitted by a person (e.g. student); (b) prompting a machine (e.g. artificial intelligence) to create a quiz comprising a plurality of multiple-choice questions with correct answers based on content in the body of text, wherein the quiz is administered online, and wherein a cumulative maximum amount of time is given to select the correct answers for all of the questions. In an example, a quiz can be timed, wherein a student is allowed a selected maximum amount of time to select answers to all questions in the quiz.

In an example, a person can select an answer in a multiple-choice online quiz by clicking on the answer, checking the answer, swiping on the answer, highlighting the answer, typing in a label (e.g. letter or number) for the answer, hovering a mouse over an answer, speaking the answer, speaking a label (e.g. letter or number) for the answer, or making a gesture which indicates the answer. In another example, a quiz to test a student's understanding of the content of a body of text which the student submits for an assignment can be administered through one of the following human-to-computer interfaces: augmented reality eyewear; computer display and/or screen; gesture recognition; inertial motion sensor; keyboard or keypad; microphone and speech recognition; mouse or other pointing device; touchpad; and touchscreen.

In an example, a method for testing a person's understanding of a submitted body of text can comprise creating and administering a quiz with 5 to 20 multiple choice questions based on 5 to 20 target strings (e.g. words or phrases) selected from the submitted body of text, wherein the target strings are selected by a machine (e.g. artificial intelligence). In another example, generative AI can be used to generate a multiple-choice quiz based on a body of text submitted by a student for an assignment and administer the quiz to the student online, wherein questions in the quiz present the student with selected words and/phrases used in the body of text and ask the student to select other words or phrases with the most similar meanings to the selected words or phrases.

In an example, a machine (e.g. artificial intelligence) can be prompted to select set of statements from a body of text submitted by a person and prompted to generate questions based on these statement, wherein these questions test the person's understanding of the statements. As another embodiment, integration of AI into analysis of an assignment submitted by a student can improve the functionality of a learning management system by automatically generating a quiz which tests the student's understanding of core statements and/or concepts expressed in their assignment submission. This is a tangible and practical advance over use of current use of AI to estimate the probability that the assignment was generated by AI (or the percentage of an assignment that is likely generated by AI). Providing an instructor with a percentage chance of a submission being written by AI puts the instructor on the spot (what to do about it?) and does not improve learning. An automatically-generated quiz of student understanding puts the focus back on learning, not a cat-and-mouse game of AI use and detection.

In an example, when a machine process (e.g. artificial intelligence) is used to create quiz questions and answers based on the content of a body of text submitted by a student for an assignment, then the prompt for the machine process can specify that questions and answers are to be based only on content in that body of text (e.g. not material on which the machine process has been previously trained). If the machine process (e.g. artificial intelligence) evaluates content in that body of text to be erroneous and/or incorrect, then the machine process can indicate this to the student in an interaction separate from the quiz. This can help to ensure that the objectives of testing a student's understanding of what they wrote is not confounded with independent instructional content. Also, current machine processes (e.g. artificial intelligence systems) are not perfect, so it is best to keep verification of authorship separate from correction of content at this point. If, in future years, machine processes (e.g. artificial intelligence systems) become perfect, then the two may be combined.

In an example, a method for testing a student's understanding of content in a body of text which the student submitted for an assignment can comprise prompting a machine process (e.g. artificial intelligence) to perform one or more of the following steps: evaluating the rarity or vocabulary level of target strings (e.g. words or phrases); identifying string synonyms for (e.g. words or phrases with the same meaning as) target strings; identifying the most important words, phrase, and/or statements in the body of text; identifying the primary field of a body of text (e.g. for selection of a field-specific database); identifying the words, phrases, and/or statements in the body of text which are most relevant to the assignment topic or instructions; scanning the body of text to identify target strings (e.g. words or phrases); selecting a subset of target strings for inclusion in a quiz to test the student's understanding; and selecting word or phrases in the body of text which are most unusual, most rare, or having the highest vocabulary levels.

In an example, a method for testing a student's understanding of content in a body of text which the student submitted for an assignment can comprise using a machine process (e.g. large language model AI) to perform one or more of the following steps: evaluating the rarity or vocabulary level of target strings (e.g. words or phrases); identifying string synonyms for (e.g. words or phrases with the same meaning as) target strings; identifying the most important words, phrase, and/or statements in the body of text; identifying the primary field of a body of text (e.g. for selection of a field-specific database); identifying the words, phrases, and/or statements in the body of text which are most relevant to the assignment topic or instructions; scanning the body of text to identify target strings (e.g. words or phrases); selecting a subset of target strings for inclusion in a quiz to test the student's understanding; and selecting word or phrases in the body of text which are most unusual, most rare, or having the highest vocabulary levels.

In an example, a method for testing a student's understanding of a body of text submitted by the student for an assignment can include modifying (e.g. in real time) the subsequent questions in a quiz based on the student's answers to previous questions, wherein the difficulty level of subsequent questions is increased when the student selects more correct answers in previous questions and the difficulty level of subsequent questions is decreased when the student selected fewer correct answer in previous questions.

In an example, a method for testing a student's understanding of a body of text submitted by the student for an assignment can include using a machine process (e.g. artificial intelligence) to modify (e.g. in real time) the subsequent questions in a quiz based on the student's answers to previous questions, wherein the difficulty level of subsequent questions is increased when the student selects more correct answers in previous questions and the difficulty level of subsequent questions is decreased when the student selected fewer correct answer in previous questions.

In an example, a quiz can have a number of questions concerning a body of text submitted by a student for an assignment, wherein the number of questions is a function of one or more of the following: the size of the body of text (e.g. number of characters or words); the cumulative performance of the student on questions (e.g. presenting more questions until the student's performance clearly indicates understanding or lack of understanding of the body of text, and then ending the quiz); the number of strings (e.g. words or phrases) in the body of text which are found in a phrase synonym database; a number of questions for the quiz selected by the course instructor; and the rarity scores and/or vocabulary levels of strings (e.g. words or phrases) used in the body of text.

In an example, the number of questions in a multiple-choice quiz generated based on the content of the body of text submitted by a student for an assignment can vary (e.g. depending on how well or poorly a student does in cumulative questions). In an example, additional quiz questions can be generated if the results of answers to cumulative questions are ambiguous with respect to whether the student understands the content of the body of text. In an example, additional questions can be asked until it is clear (e.g. with a selected probability) that the student does, or does not, understand the content of the body of text.

In an example, a body of text to be analyzed by this method can be submitted and/or uploaded as a file. In another example, a method can be embodied in an electronic, magnetic, electromagnetic, optical, and/or semiconductor system. In an example, a method can be implemented in a device selected from the group consisting of: cellphone, computer server, desktop computer, electronic tablet and/or pad, laptop computer, personal digital assistant, smart glasses, and smart watch. In an example, a method can be implemented on a digital signal processor, a discrete element circuit, a general purpose computer, a microcontroller, a microprocessor, a peripheral integrated circuit element, a programmable logic device, and/or a special purpose computer.

In an example, a method can be implemented using a phone or other mobile computing system. In an example, a method can be implemented within a computer, a central processing unit (CPU), a computing platform, and/or a computing system. In an example, the methods disclosed herein can be embodied in a computer network, a computer program, a computer system, a data processor, a data storage medium, a sequence of executable commands, computing hardware, a machine-learning process, computing software, and/or lines of code.

In an example, a method can be a computer-implemented pipeline that extracts content from a body of text submitted by a student to a school's Learning Management System (e.g. via LTI) and produces a reviewable assessment item (e.g. such as a quiz) that is strictly-grounded in that submitted body of text. For example, this method can comprise: (a) normalizing and segmenting the body of text; (b) scoring strings (e.g. words, phrases, or sentences) for salience; and (c) building a structured instruction for a Large Language Model (LLM) that operates in a closed-book manner on the supplied text only. In this embodiment, a student's submission is the sole source of truth for the generated quiz.

In an example, a model can: draft candidate questions (e.g. which ask a student to perform synonym identification, factual recall, and/or theme expression) in a defined JSON schema; and use deterministic validators to enforce schema conformance, deduplicate, and run a context-consistency check requiring each question and keyed answer to be directly supported by the student's submitted body of text. In an embodiment, items which are not supported (e.g. justified) by the submitted body of text can be rejected or regenerated. In an example, each run can record an audit trail (input reference, prompt/version, model identifier/parameters, validator outcomes) for reproducibility and human review. In an example, only approved items and scores are returned to the LTI application. The inventive and technological contributions of this method include controlled architecture and pre-analysis, leading to closed-book LLM drafting, in turn leading to strict text-grounded validation with human-in-the-loop. This sequence reliably converts long-form student work into traceable and reviewable assessments.

In an example, a method can be embodied a set of instructions and/or commands which are stored in a computer-readable storage medium. In an example, a method can be implemented by software, a computer program, and/or a computer code. In an example, a method can be implemented in an operating system environment selected from the group consisting of: Android, Chrome OS, HolOS, Linux, Mac OS, OS, Ubuntu, UNIX, and Windows. In an example, a method can be implemented via flash memory, holographic memory, random access memory (RAM), or read only memory (ROM). In an example, a method for measuring a student's understanding of a body of text which the student submits for an assignment can be implemented using a non-transitory computer program product with a computer-readable storage medium. In an example, implementation of a method can include insertion of computer code into a website template.

In an example, a (character) string can be a word, a phrase, or a statement. As another embodiment, a body of text to be analyzed by this method must have a minimum number of words. In an example, a method for measuring a student's understanding of a body of text submitted by the student for an assignment can include using (e.g. prompting) a machine process (e.g. artificial intelligence) to identify the body of text as being of one of the following types: biographic profile, blog entry, book report, business analysis, case study analysis, composition, discussion post, dissertation, editorial, editorial piece, email, essay, financial analysis, financial valuation, grant proposal, journal article, journal article review, lab report, legal brief, letter, literature review, magazine article, marketing plan, master's thesis, medical notes, movie review, news article, novel, patent application, performance review, pitch deck, play, poem, public speech, real property description, report, research paper, resume or CV, screen play, short story, slide show, song lyrics, strategic plan, SWOT analysis, and valuation analysis.

I claim:

1. A method for measuring a student's knowledge of a body of text submitted for an assignment comprising:
receiving a body of text submitted for an assignment by a student; and
creating questions for the student based on the body of text, wherein the questions comprise an assessment tool to measure the student's knowledge of content in the body of text.

2. The method in claim 1 wherein the method further comprises creating a question: (a) presenting the student with a plurality of strings; wherein a string is a string of characters comprising a word, a phrase, or a statement; and wherein one string in the plurality is in the body of text and the other strings in the plurality are not in the body of text; and (b) asking the student to select the string which is in the body of text.

3. The method in claim 1 wherein the method further comprises creating a question: (a) presenting the student with a plurality of strings; wherein a string is a string of characters comprising a word, a phrase, or a statement; and wherein one string in the plurality is not in the body of text and the other strings in the plurality are in the body of text; and (b) asking the student to select the string which is not in the body of text.

4. The method in claim 1 wherein the method further comprises creating a question: (a) presenting the student with a target string from the body of text with one or more words missing; wherein a string is a string of characters comprising a word, a phrase, or a statement; and (b) asking the student to select a string from among a plurality of alternative strings wherein insertion of the selected string for the one or more missing words gives the target string its original meaning in the body of text.

5. A method for measuring a student's knowledge of a body of text submitted for an assignment comprising:
receiving a first body of text submitted for an assignment by a student;
selecting target strings from among strings found in the first body of text, wherein a string is a string of characters comprising a word, a phrase, or a statement; and
creating questions for the student based on the target strings, wherein the questions comprise an assessment tool to measure the student's knowledge of content in the first body of text.

6. The method in claim 5 wherein the method further comprises selecting target strings at least partly based on the infrequency and/or rarity with which strings have previously been found in a second body of text, wherein the second body of text is at least three orders of magnitude larger than the first body of text, and wherein strings which are more infrequent and/or rare are more likely to be selected as target strings.

7. The method in claim 6 wherein the method further comprises using a previously-created database containing data concerning the infrequency and/or rarity of strings to help select target strings.

8. The method in claim 6 wherein the method further comprises using artificial intelligence or other machine assistance to evaluate the infrequency and/or rarity of strings to help select target strings.

9. The method in claim 5 wherein the method further comprises selecting target strings at least partly based on the vocabulary levels of one or more words in the strings and wherein strings with higher vocabulary levels are more likely to be selected as target strings.

10. The method in claim 9 wherein the method further comprises using a previously-created database containing data concerning the vocabulary levels of strings to help select target strings.

11. The method in claim 9 wherein the method further comprises using artificial intelligence or other machine assistance to evaluate the vocabulary levels of strings to help select target strings.

12. The method in claim 5 wherein the method further comprises selecting target strings at least partly based on the relevance, importance, and/or significance of the strings to the assignment and wherein strings with greater relevance, importance, and/or significance are more likely to be selected as target strings.

13. The method in claim 12 wherein the method further comprises using artificial intelligence or other machine assistance to evaluate the relevance, importance, and/or significance of strings to help select target strings.

14. The method in claim 5 wherein the method further comprises creating questions which measure the student's understanding of the meanings of the target strings.

15. The method in claim 14 wherein the method further comprises creating a question: (a) presenting the student with a target string; and (b) asking the student to select a string with a meaning which is closest to the meaning of the target string from among a plurality of alternative strings.

16. The method in claim 15 wherein the method further comprises using a previously-created database concerning strings which are close in meaning to each other to help identify a string with a meaning close to the meaning of the target string.

17. The method in claim 15 wherein the method further comprises using artificial intelligence or other machine assistance to identify a string with a meaning close to the meaning of the target string.

18. The method in claim 14 wherein the method further comprises creating a question: (a) presenting the student with a target string from the first body of text with one or more words missing; and (b) asking the student to select a string from among a plurality of alternative strings wherein insertion of the selected string for the one or more missing words gives the target string its original meaning in the first body of text.

19. The method in claim 14 wherein the method further comprises using artificial intelligence or other machine assistance to create a question: (a) presenting the student with a target string; and (b) asking the student to select a string from among a plurality of alternative strings which is consistent with, agrees with, and/or supports the target string.

20. The method in claim 14 wherein the method further comprises using artificial intelligence or other machine assistance to create a question: (a) presenting the student with a target string; and (b) asking the student to select a string from among a plurality of alternative strings which is inconsistent with, disagrees with, and/or does not support the target string.
